(19) United States
(12) Patent Application Publication
(10) Pub. No.: US 2025/0287376 A1
(43) Pub. Date: Sep. 11, 2025

(54) METHOD FOR TRANSMITTING UPLINK SIGNAL, USER EQUIPMENT, PROCESSING DEVICE, STORAGE MEDIUM, AND METHOD AND BASE STATION FOR RECEIVING UPLINK SIGNAL

(71) Applicant: LG ELECTRONICS INC., Seoul (KR)

(72) Inventors: Seunghwan CHOI, Seoul (KR); Joonkui AHN, Seoul (KR); Suckchel YANG, Seoul (KR); Seonwook KIM, Seoul (KR)

(73) Assignee: LG ELECTRONICS INC., Seoul (KR)

(21) Appl. No.: 18/860,578

(22) PCT Filed: Apr. 26, 2023
(86) PCT No.: PCT/KR2023/005655

§ 371 Date: Oct. 25, 2024

(30) Foreign Application Priority Data
Apr. 28, 2022 (KR) 10-2022-0053110
May 10, 2022 (KR) 10-2022-0057032

(51) Int. Cl. H04W 72/1268; H04W 72/21

(52) U.S. Cl. CPC H04W 72/1268; H04W 72/21

(57) ABSTRACT

The UE omits a UL transmission during a UL switching gap based on UTS conditions being satisfied for a current transmission. The UTS conditions may include: i) a preceding transmission occurs in another band different from a band for the current transmission, based on the current transmission being a two-port transmission; ii) the preceding transmission is neither a one-port transmission nor a two-port transmission in the band for the current transmission, based on the current transmission being a one-port transmission and transmissions in different bands being permitted; iii) the preceding transmission is not a one-port transmission in a first band, a one-port transmission in a second band, or a one-port transmission in each of the first and second bands, based on the current transmission being a one-port transmission in the first band and a one-port transmission in the second band and UL transmissions in different bands being permitted.

### CROSS-REFERENCE TO RELATED APPLICATION(S)

This application is the National Stage filing under 35 U.S.C. 371 of International Application No. PCT/KR2023/005655, filed on Apr. 26, 2023, which claims the benefit of earlier filing date and right of priority to Korean Application Nos. 10-2022-0053110, filed on Apr. 28, 2022, and 10-2022-0057032, filed on May 10, 2022, the contents of which are all incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

### SUMMARY

As new radio communication technology has been introduced, the number of UEs to which a BS should provide services in a prescribed resource region is increasing and the volume of data and control information that the BS transmits/receives to/from the UEs to which the BS provides services is also increasing. Since the amount of resources available to the BS for communication with the UE(s) is limited, a new method for the BS to efficiently receive/transmit uplink/downlink data and/or uplink/downlink control information from/to the UE(s) using the limited radio resources is needed. In other words, due to increase in the density of nodes and/or the density of UEs, a method for efficiently using high-density nodes or high-density UEs for communication is needed.

In general, regarding a UE, the number of antennas that can be installed in the corresponding UE is limited due to its size. For example, a UE with N transmission chains through N antennas may support up to N uplink transmissions. There is a need for a plan for supporting a UE having a limited number of transmission chains to effectively perform uplink transmission.

The objects to be achieved with the present disclosure are not limited to what has been particularly described hereinabove and other objects not described herein will be more clearly understood by persons skilled in the art from the following detailed description.

In one technical aspect of the present disclosure, provided is a method of transmitting an Uplink (UL) signal by a User Equipment (UE) in a wireless communication system. The method may include receiving an RRC configuration including Uplink Transmission Switching (UTS) related information regarding a plurality of bands including at least a first band, a second band, and a third band, receiving scheduling information for scheduling a current UL transmission in at least one of a plurality of the bands, determining whether UTS conditions are satisfied for the current UL transmission based on the RRC configuration, the scheduling information, and a UL transmission preceding the current UL transmission, omitting a UL transmission during a UL switching gap based on the UTS conditions being satisfied, and performing the preceding UL transmission and the current UL transmission without interruption based on the UTS conditions not being satisfied. The UTS conditions may include the following. i) A first condition-based on the current UL transmission being a 2-port transmission, the preceding UL transmission occurs in at least one band other than a band in which the current UL transmission occurs. ii) A second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs. And, iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In another technical aspect of the present disclosure, provided is user equipment transmitting an Uplink (UL) signal in a wireless communication system. The user equipment may include at least one transceiver. at least one processor, and at least one computer memory operably connected to the at least one processor and storing instructions causing the at least one processor to perform operations when executed. The operations may include receiving an RRC configuration including Uplink Transmission Switching (UTS) related information regarding a plurality of bands including at least a first band, a second band, and a third band, receiving scheduling information for scheduling a current UL transmission in at least one of a plurality of the bands, determining whether UTS conditions are satisfied for the current UL transmission based on the RRC configuration, the scheduling information, and a UL transmission preceding the current UL transmission, omitting a UL transmission during a UL switching gap based on the UTS conditions being satisfied, and performing the preceding UL transmission and the current UL transmission without interruption based on the UTS conditions not being satisfied. The UTS conditions may include the following. i) A first condition-based on the current UL transmission being a 2-port transmission, the preceding UL transmission occurs in at least one band other than a band in which the current UL transmission occurs. ii) A second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs. And, iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In another technical aspect of the present disclosure, provided is an apparatus for processing in a wireless communication system. The apparatus may include at least one processor and at least one computer memory operably connected to the at least one processor and storing instructions causing the at least one processor to perform operations when executed. The operations may include receiving an RRC configuration including Uplink Transmission Switching (UTS) related information regarding a plurality of bands including at least a first band, a second band, and a third band, receiving scheduling information for scheduling a current UL transmission in at least one of a plurality of the bands, determining whether UTS conditions are satisfied for the current UL transmission based on the RRC configuration, the scheduling information, and a UL transmission preceding the current UL transmission, omitting a UL transmission during a UL switching gap based on the UTS conditions being satisfied, and performing the preceding UL transmission and the current UL transmission without interruption based on the UTS conditions not being satisfied. The UTS conditions may include the following. i) A first condition-based on the current UL transmission being a 2-port transmission, the preceding UL transmission occurs in at least one band other than a band in which the current UL transmission occurs. ii) A second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs. And, iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In another technical aspect of the present disclosure, provided is a storage medium readable by a computer. The storage medium may store at least one computer program code including instructions causing at least one processor to perform operations when executed. The operations may include receiving an RRC configuration including Uplink Transmission Switching (UTS) related information regarding a plurality of bands including at least a first band, a second band, and a third band, receiving scheduling information for scheduling a current UL transmission in at least one of a plurality of the bands, determining whether UTS conditions are satisfied for the current UL transmission based on the RRC configuration, the scheduling information, and a UL transmission preceding the current UL transmission, omitting a UL transmission during a UL switching gap based on the UTS conditions being satisfied, and performing the preceding UL transmission and the current UL transmission without interruption based on the UTS conditions not being satisfied. The UTS conditions may include the following. i) A first condition-based on the current UL transmission being a 2-port transmission, the preceding UL transmission occurs in at least one band other than a band in which the current UL transmission occurs. ii) A second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs. And, iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In another technical aspect of the present disclosure, provided is a computer program stored in a computer-readable storage medium. The computer program may include at least one program code including instructions causing at least one processor to perform operations when executed. The operations may include receiving an RRC configuration including Uplink Transmission Switching (UTS) related information regarding a plurality of bands including at least a first band, a second band, and a third band, receiving scheduling information for scheduling a current UL transmission in at least one of a plurality of the bands, determining whether UTS conditions are satisfied for the current UL transmission based on the RRC configuration, the scheduling information, and a UL transmission preceding the current UL transmission, omitting a UL transmission during a UL switching gap based on the UTS conditions being satisfied, and performing the preceding UL transmission and the current UL transmission without interruption based on the UTS conditions not being satisfied. The UTS conditions may include the following. i) A first condition-based on the current UL transmission being a 2-port transmission, the preceding UL transmission occurs in at least one band other than a band in which the current UL transmission occurs. ii) A second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs. And, iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In another technical aspect of the present disclosure, provided is a method of receiving an Uplink (UL) signal from a User Equipment (UE) by a base station in a wireless communication system. The method may include transmitting an RRC configuration including Uplink Transmission Switching (UTS) related information on a plurality of bands including at least a first band, a second band, and a third band to the user equipment, transmitting scheduling information for scheduling a current UL transmission in at least one of a plurality of the bands to the user equipment, determining whether UTS conditions are satisfied for the current UL transmission based on the RRC configuration, the scheduling information, and a UL transmission preceding the current UL transmission, omitting a reception of a UL transmission of the UE during a UL switching gap based on the UTS conditions being satisfied, and performing a reception of the preceding UL transmission and the current UL transmission from the user equipment without interruption based on the UTS conditions not being satisfied. The UTS conditions may include the following. i) A first condition-based on the current UL transmission being a 2-port transmission, the preceding UL transmission occurs in at least one band other than a band in which the current UL transmission occurs. ii) A second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs. And, iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In another technical aspect of the present disclosure, provided is a base station receiving an Uplink (UL) signal from a user equipment in a wireless communication system. The base station may include at least one transceiver, at least one processor, and at least one computer memory operably connected to the at least one processor and storing instructions causing the at least one processor to perform operations when executed. The operations may include transmitting an RRC configuration including Uplink Transmission Switching (UTS) related information regarding a plurality of bands including at least a first band, a second band, and a third band to the user equipment, transmitting scheduling information for scheduling a current UL transmission in at least one of a plurality of the bands to the user equipment, determining whether UTS conditions are satisfied for the current UL transmission based on the RRC configuration, the scheduling information, and a UL transmission preceding the current UL transmission, omitting a reception of a UL transmission of the UE during a UL switching gap based on the UTS conditions being satisfied, and performing a reception of the preceding UL transmission and the current UL transmission from the user equipment without interruption based on the UTS conditions not being satisfied. The UTS conditions may include i) a first condition-based on the current UL transmission being a 2-port transmission, the preceding UL transmission occurs in at least one band other than a band in which the current UL transmission occurs, ii) a second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs; and iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

In each technical aspect of the present disclosure, the method of the user equipment or the operations of the user equipment, the processing device or the storage medium may include in relation to the third condition, transmitting a UE capability report regarding whether to perform the UTS only for the UL transmission in the second band or for UL transmissions in both the first band and the second band and omitting the UL transmission in the first band or the UL transmissions in the first band and the second band based on the third condition being satisfied and based on the UE capability report.

In each technical aspect of the present disclosure, the method of the user equipment or the operations of the user equipment, the processing device or the storage medium may include in relation to the third condition, receiving configuration information regarding whether to perform the UTS only for the UL transmission in the second band or for UL transmissions in both the first band and the second band and omitting the UL transmission in the first band or the UL transmissions in the first band and the second band according to the configuration information based on the third condition being satisfied.

In each technical aspect of the present disclosure, the method of the user equipment or the operations of the user equipment, the processing device or the storage medium may include in relation to the second condition, performing a UE capability report regarding whether to switch only one of two Transmission (Tx) chains or both of the two Tx chains and based on the second condition being satisfied and based on the UE capability report, switching only one of the two Tx chains of the user equipment to the band of the current UL transmission or both of the two Tx chains to the band of the current UL transmission.

In each technical aspect of the present disclosure, the method of the user equipment or the operations of the user equipment, the processing device or the storage medium may include in relation to the second condition, receiving configuration information regarding whether to switch only one of two Transmission (Tx) chains of the user equipment or both of the two Tx chains and based on the second condition being satisfied, according to the configuration information, switching only one of the two Tx chains of the UE to the band of the current UL transmission or both of the two Tx chains to the band of the current UL transmission.

In each technical aspect of the present disclosure, the method of the base station or the operations may include in relation to the third condition, receiving a UE capability report on whether to perform the UTS only for the UL transmission in the second band or for UL transmissions in both the first band and the second band and band based on the third condition being satisfied and based on the UE capability report, omitting the UL transmission in the first band or the UL transmissions in the first band and the second.

In each technical aspect of the present disclosure, the method of the base station or the operations may include in relation to the third condition, transmitting configuration information regarding whether to perform the UTS only for the UL transmission in the second band or for UL transmissions in both the first band and the second band and omitting the UL transmission in the first band or a reception of the UL transmissions in the first band and the second band according to the configuration information based on the third condition being satisfied.

In each technical aspect of the present disclosure, the method of the base station or the operations may include in relation to the second condition, receiving a UE capability report regarding whether to switch only one of two Transmission (Tx) chains of the user equipment or both of the two Tx chains and based on the second condition being satisfied and based on the UE capability report, determining that only one of the two Tx chains of the user equipment is switched to the band of the current UL transmission or that both of the two Tx chains are switched to the band of the current UL transmission.

In each technical aspect of the present disclosure, the method of the base station or the operations may include in relation to the second condition, receiving configuration information regarding whether to switch only one of two Transmission (Tx) chains of the user equipment or both of the two Tx chains and based on the second condition being satisfied, according to the configuration information, determining or assuming that only one of the two Tx chains of the user equipment is switched to the band of the current UL transmission or that both of the two Tx chains are switched to the band of the current UL transmission.

In each technical aspect of the present disclosure, based on the third condition being satisfied, based on the 1-port transmission in the first band and the 1-port transmission in the second band overlapping each other in time, and based on a start of the 1-port transmission in the first band and a start of the 1-port transmission in the second band not matching, the UL switching gap may be determined based on a preceding UL transmission between the 1-port transmission in the first band and the 1-port transmission in the second band.

In each technical aspect of the present disclosure, a reception of the 1-port transmission in the first band and the 1-port transmission in the second band overlapping each other in time may be omitted during the switching gap determined based on the preceding UL transmission between the 1-port transmission in the first band and the 1-port transmission in the second band.

The foregoing solutions are merely a part of the examples of the present disclosure and various examples into which the technical features of the present disclosure are incorporated may be derived and understood by persons skilled in the art from the following detailed description.

According to some implementation(s) of the present disclosure, a wireless communication signal may be efficiently transmitted/received. Accordingly, the total throughput of a wireless communication system may be raised.

According to some implementation(s) of the present disclosure, various services with different requirements may be efficiently supported in a wireless communication system.

According to some implementation(s) of the present disclosure, delay/latency generated during radio communication between communication devices may be reduced.

The effects according to the present disclosure are not limited to what has been particularly described hereinabove and other effects not described herein will be more clearly understood by persons skilled in the art related to the present disclosure from the following detailed description.

### BRIEF DESCRIPTION OF THE DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied:

FIG. 2 is a block diagram illustrating examples of communication devices capable of performing a method according to the present disclosure:

FIG. 3 illustrates another example of a wireless device capable of performing implementation(s) of the present disclosure:

FIG. 4 illustrates an example of a frame structure used in a 3rd generation partnership project (3GPP)-based wireless communication system:

FIG. 5 illustrates a resource grid of a slot:

FIG. 6 illustrates an example of physical downlink shared channel (PDSCH) time domain resource assignment (TDRA) caused by a physical downlink control channel (PDCCH) and an example of physical uplink shared channel (PUSCH) TDRA caused by the PDCCH;

FIG. 7 is a diagram to describe the concept of uplink transmission switching:

FIGS. 8 to 10 illustrate Uplink Transmission Switching (UTS) triggering condition(s) or condition(s) for not triggering UTS according to some implementations of the preset disclosure:

FIG. 11 illustrates an example of a flow of an uplink signal transmission in a User Equipment (UE) according to some implementations of the present disclosure; and

FIG. 12 illustrates an example of a flow of UL signal reception in a BS according to some implementations of the present disclosure.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.331, etc.

In examples of the present disclosure described later, if a device “assumes” something, this may mean that a channel transmission entity transmits a channel in compliance with the corresponding “assumption”. This also may mean that a channel reception entity receives or decodes the channel in the form of conforming to the “assumption” on the premise that the channel has been transmitted in compliance with the “assumption”.

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a node refers to a fixed point capable of transmitting/receiving a radio signal to/from a UE by communication with the UE. Various types of BSs may be used as nodes regardless of the names thereof. For example, a BS, NB, eNB, pico-cell eNB (PeNB), home eNB (HeNB), relay, repeater, etc. may be a node. Furthermore, a node may not be a BS. For example, a radio remote head (RRH) or a radio remote unit (RRU) may be a node. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per node. An antenna may refer to a physical antenna port or refer to a virtual antenna or an antenna group. The node may also be called a point.

In the present disclosure, a cell refers to a specific geographical area in which one or more nodes provide communication services. Accordingly, in the present disclosure, communication with a specific cell may mean communication with a BS or a node providing communication services to the specific cell. A DL/UL signal of the specific cell refers to a DL/UL signal from/to the BS or the node providing communication services to the specific cell. A cell providing UL/DL communication services to a UE is especially called a serving cell. Furthermore, channel status/quality of the specific cell refers to channel status/quality of a channel or a communication link generated between the BS or the node providing communication services to the specific cell and the UE. In 3GPP-based communication systems, the UE may measure a DL channel state from a specific node using cell-specific reference signal(s) (CRS(s)) transmitted on a CRS resource and/or channel state information reference signal(s) (CSI-RS(s)) transmitted on a CSI-RS resource, allocated to the specific node by antenna port(s) of the specific node.

A 3GPP-based communication system uses the concept of a cell in order to manage radio resources, and a cell related with the radio resources is distinguished from a cell of a geographic area.

The “cell” of the geographic area may be understood as coverage within which a node may provide services using a carrier, and the “cell” of the radio resources is associated with bandwidth (BW), which is a frequency range configured by the carrier. Since DL coverage, which is a range within which the node is capable of transmitting a valid signal, and UL coverage, which is a range within which the node is capable of receiving the valid signal from the UE, depend upon a carrier carrying the signal, coverage of the node may also be associated with coverage of the “cell” of radio resources used by the node. Accordingly, the term “cell” may be used to indicate service coverage by the node sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. For example, the combination of the DL resources and the UL resources may be indicated by system information block type 2 (SIB2) linkage. In this case, the carrier frequency may be equal to or different from a center frequency of each cell or CC. When carrier aggregation (CA) is configured, the UE has only one radio resource control (RRC) connection with a network. During RRC connection establishment/re-establishment/handover, one serving cell provides non-access stratum (NAS) mobility information. During RRC connection re-establishment/handover, one serving cell provides security input. This cell is referred to as a primary cell (Pcell). The Pcell refers to a cell operating on a primary frequency on which the UE performs an initial connection establishment procedure or initiates a connection re-establishment procedure. According to UE capability, secondary cells (Scells) may be configured to form a set of serving cells together with the Pcell. The Scell may be configured after completion of RRC connection establishment and used to provide additional radio resources in addition to resources of a specific cell (SpCell). A carrier corresponding to the Pcell on DL is referred to as a downlink primary CC (DL PCC), and a carrier corresponding to the Pcell on UL is referred to as an uplink primary CC (UL PCC). A carrier corresponding to the Scell on DL is referred to as a downlink secondary CC (DL SCC), and a carrier corresponding to the Scell on UL is referred to as an uplink secondary CC (UL SCC).

In a dual connectivity (DC) operation, the term special cell (SpCell) refers to a Pcell of a master cell group (MCG) or a primary secondary cell (PSCell) of a secondary cell group (SCG). The SpCell supports PUCCH transmission and contention-based random access and is always activated. The MCG is a group of service cells associated with a master node (e.g., BS) and includes the SpCell (Pcell) and optionally one or more Scells. For a UE configured with DC, the SCG is a subset of serving cells associated with a secondary node and includes the PSCell and 0 or more Scells. The PSCell is a primary Scell of the SCG. For a UE in RRC_CONNECTED state, that is not configured with CA or DC, only one serving cell including only the Pcell is present. For a UE in RRC_CONNECTED state, that is configured with CA or DC, the term serving cells refers to a set of cells including SpCell(s) and all Scell(s). In DC, two medium access control (MAC) entities, i.e., one MAC entity for the MCG and one MAC entity for the SCG, are configured for the UE.

For a UE that is configured with CA and is not configured with DC, a Pcell PUCCH group (also called a primary PUCCH group) including the Pcell and 0 or more Scells and an Scell PUCCH group (also called a secondary PUCCH group) including only Scell(s) may be configured. For the Scell, an Scell on which a PUCCH associated with the corresponding cell is transmitted (hereinafter, a PUCCH cell) may be configured. An Scell for which a PUCCH Scell is indicated belongs to the Scell PUCCH group (i.e., the secondary PUCCH group) and PUCCH transmission of related uplink control information (UCI) is performed on the PUCCH Scell. If a PUCCH Scell is not indicated for an Scell or a cell which is indicated for PUCCH transmission for the Scell is a Pcell, the Scell belongs to the Pcell PUCCH group (i.e., the primary PUCCH group) and PUCCH transmission of related UCI is performed on the Pcell. Hereinbelow, if the UE is configured with the SCG and some implementations of the present disclosure related to a PUCCH are applied to the SCG, the primary cell may refer to the PSCell of the SCG. If the UE is configured with the PUCCH Scell and some implementations of the present disclosure related to the PUCCH are applied to the secondary PUCCH group, the primary cell may refer to the PUCCH Scell of the secondary PUCCH group.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, a PDCCH refers to a set of time-frequency resources (e.g., resource elements (REs)) carrying downlink control information (DCI), and a PDSCH refers to a set of time-frequency resources carrying DL data. A PUCCH, a PUSCH, and a PRACH refer to a set of time-frequency resources carrying UCI, a set of time-frequency resources carrying UL data, and a set of time-frequency resources carrying random access signals, respectively. In the following description, “the UE transmits/receives a PUCCH/PUSCH/PRACH” is used as the same meaning that the UE transmits/receives the UCI/UL data/random access signals on or through the PUCCH/PUSCH/PRACH, respectively. In addition, “the BS transmits/receives a PBCH/PDCCH/PDSCH” is used as the same meaning that the BS transmits the broadcast information/DCI/DL data on or through a PBCH/PDCCH/PDSCH, respectively.

In the present disclosure, a radio resource (e.g., a time-frequency resource) scheduled or configured to the UE by the BS for transmission or reception of the PUCCH/PUSCH/PDSCH may be referred to as a PUCCH/PUSCH/PDSCH resource.

Since a communication device receives a synchronization signal block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver, or may not select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, not receiving physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

As more and more communication devices have required greater communication capacity, there has been a need for eMBB communication relative to legacy radio access technology (RAT). In addition, massive MTC for providing various services at anytime and anywhere by connecting a plurality of devices and objects to each other is one main issue to be considered in next-generation communication. Further, communication system design considering services/UEs sensitive to reliability and latency is also under discussion. The introduction of next-generation RAT is being discussed in consideration of eMBB communication, massive MTC, ultra-reliable and low-latency communication (URLLC), and the like. Currently, in 3GPP, a study on the next-generation mobile communication systems after EPC is being conducted. In the present disclosure, for convenience, the corresponding technology is referred to as a new RAT (NR) or fifth-generation (5G) RAT, and a system using NR or supporting NR is referred to as an NR system.

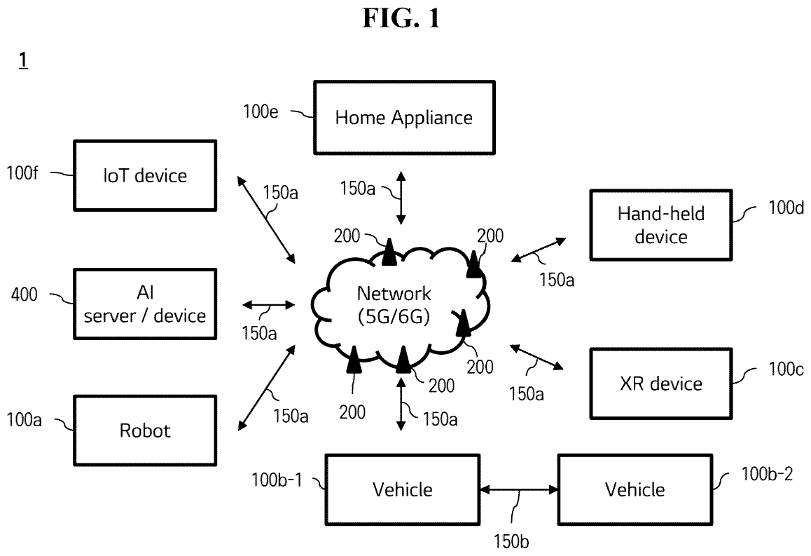

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using RAT (e.g., 5G NR or LTE (e.g., E-UTRA)) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless device may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs (e.g., 5G NR). The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

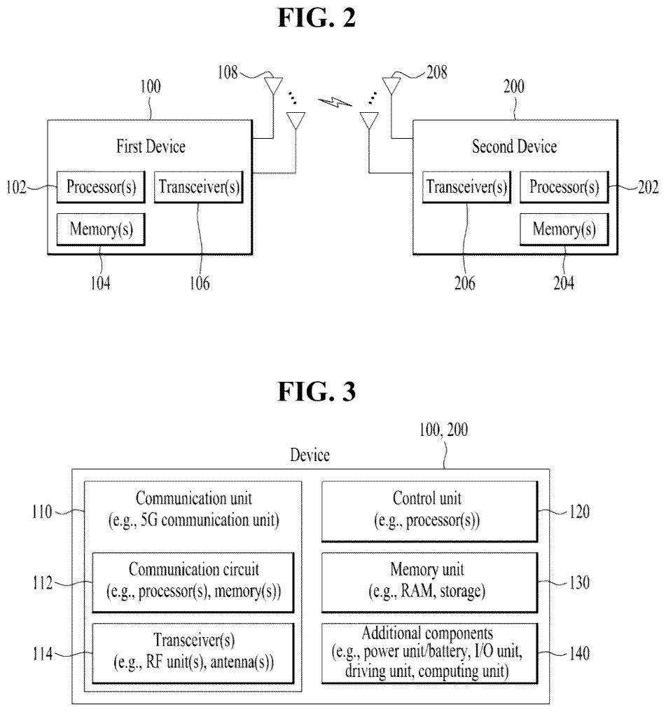

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs (e.g., LTE and NR). Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the below-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the below-described/proposed procedures and/or methods. Here, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the below-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the below-described/proposed procedures and/or methods. Here, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of things for low-power communication as well as LTE, NR, and 6G. For example, the NB-IoT technology may be an example of low-power wide-area network (LPWAN) technologies and implemented in standards such as LTE Cat NB1 and/or LTE Cat NB2. However, the NB-IoT technology is not limited to the above names. Additionally or alternatively, the wireless communication technology implemented in the wireless devices XXX and YYY of the present disclosure may perform communication based on the LTE-M technology. For example, the LTE-M technology may be an example of LPWAN technologies and called by various names including enhanced machine type communication (eMTC). For example, the LTE-M technology may be implemented in at least one of the following various standards: 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, etc., but the LTE-M technology is not limited to the above names. Additionally or alternatively, the wireless communication technology implemented in the wireless devices XXX and YYY of the present disclosure may include at least one of ZigBee, Bluetooth, and LPWAN in consideration of low-power communication, but the wireless communication technology is not limited to the above names. For example, the ZigBee technology may create a personal area network (PAN) related to small/low-power digital communication based on various standards such as IEEE 802.15.4 and so on, and the ZigBee technology may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in the present disclosure. The one or more processors 102 and 202 may generate messages, control information, data, or information according to the functions, procedures, proposals, and/or methods disclosed in the present disclosure. The one or more processors 102 and 202 may generate signals (e.g., baseband signals) including PDUs, SDUs, messages, control information, data, or information according to the functions, procedures, proposals, and/or methods disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in the present disclosure may be implemented using firmware or software, and the firmware or software may be configured to include the modules, procedures, or functions. Firmware or software configured to perform the functions, procedures, proposals, and/or methods disclosed in the present disclosure may be included in the one or more processors 102 and 202 or stored in the one or more memories 104 and 204 so as to be driven by the one or more processors 102 and 202. The functions, procedures, proposals, and/or methods disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

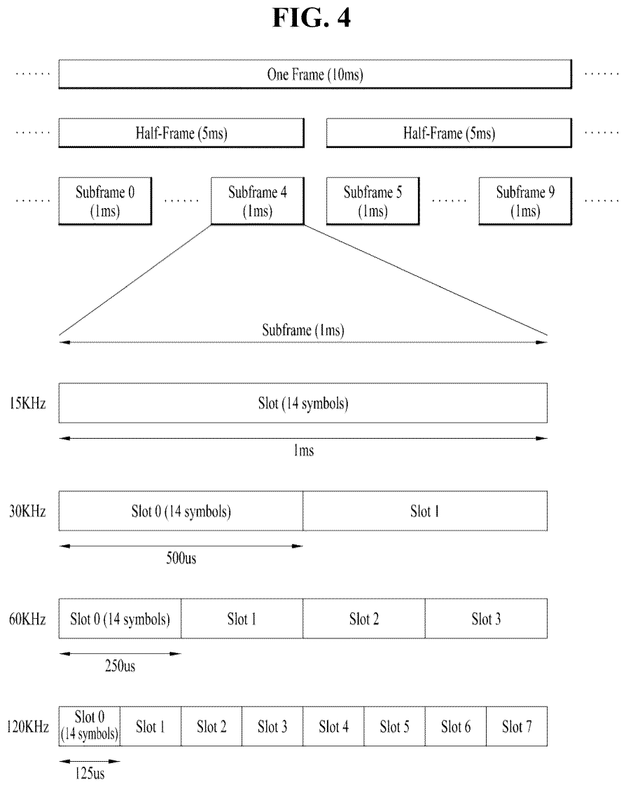

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a volatile memory, a non-transitory memory, and/or a combination thereof.

In the present disclosure, the at least one memory (e.g., 104 or 204) may store instructions or programs, and the instructions or programs may cause, when executed, at least one processor operably connected to the at least one memory to perform operations according to some embodiments or implementations of the present disclosure.

In the present disclosure, a computer readable (non-transitory) storage medium may store at least one instruction or program, and the at least one instruction or program may cause, when executed by at least one processor, the at least one processor to perform operations according to some embodiments or implementations of the present disclosure.

In the present disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the present disclosure.

In the present disclosure, a computer program may include program code stored on at least one computer-readable (non-transitory) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-transitory) storage medium.

A communication device of the present disclosure includes at least one processor; and at least one computer memory operably connected to the at least one processor and configured to store instructions for causing, when executed, the at least one processor to perform operations according to example(s) of the present disclosure described later.

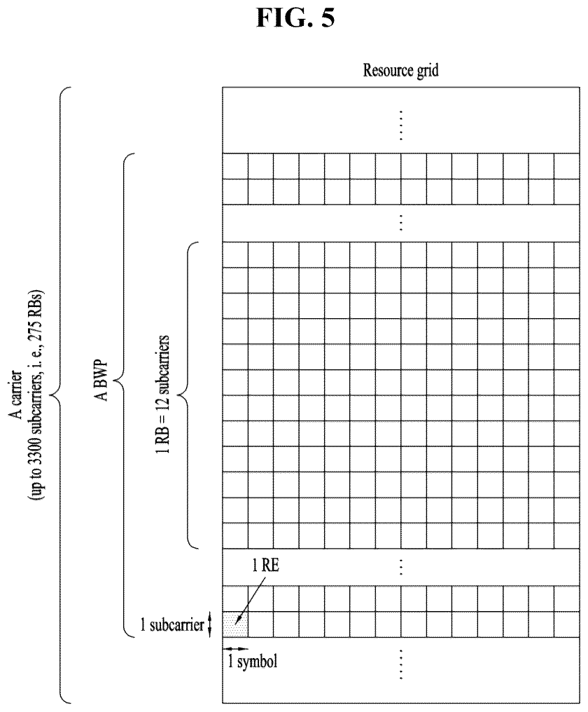

FIG. 4 illustrates an example of a frame structure used in a 3GPP-based wireless communication system.

The frame structure of FIG. 4 is purely exemplary and the number of subframes, the number of slots, and the number of symbols, in a frame, may be variously changed. In an NR system, different OFDM numerologies (e.g., subcarrier spacings (SCSs)) may be configured for multiple cells which are aggregated for one UE. Accordingly, the (absolute time) duration of a time resource including the same number of symbols (e.g., a subframe, a slot, or a transmission time interval (TTI)) may be differently configured for the aggregated cells. Here, the symbol may include an OFDM symbol (or cyclic prefix-OFDM (CP-OFDM) symbol) and an SC-FDMA symbol (or discrete Fourier transform-spread-OFDM (DFT-s-OFDM) symbol). In the present disclosure, the symbol, the OFDM-based symbol, the OFDM symbol, the CP-OFDM symbol, and the DFT-s-OFDM symbol are used interchangeably.

Referring to FIG. 4, in the NR system, UL and DL transmissions are organized into frames. Each frame has a duration of T_{f}=(Δfₘₐₓ*N_{f}/100)*T_{c}=10 ms and is divided into two half-frames of 5 ms each. A basic time unit for NR is T_{c}=1/(Δfₘₐₓ*N_{f}) where Δfₘₐₓ=480*10³ Hz and N_{f}=4096. For reference, a basic time unit for LTE is Ts=1/(Afref*Nfref) where Δf_{ref}=15*10³ Hz and N_{f,ref}=2048. T_{c} and T_{f} have the relationship of a constant κ=T_{c}/T_{f}=64. Each half-frame includes 5 subframes and a duration T_{sf} of a single subframe is 1 ms. Subframes are further divided into slots and the number of slots in a subframe depends on an SCS. Each slot includes 14 or 12 OFDM symbols based on a cyclic prefix. In a normal CP, each slot includes 14 OFDM symbols and, in an extended CP, each slot includes 12 OFDM symbols. The numerology depends on an exponentially scalable subcarrier spacing Δf=2^{u}*15 KHz. The table below shows the number of OFDM symbols (N^{slot}_{symb}) per slot, the number of slots (N^{frame,u}ₛₗₒₜ) per frame, and the number of slots (N^{subframe,u}ₛₗₒₜ) per subframe.

TABLE 1

| u | N^{slot}_{symb} | N^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The table below shows the number of OFDM symbols per slot, the number of slots per frame, and the number of slots per subframe, according to the SCS Δf=2^{u}4*15 KHz.

TABLE 2

| u | N^{slot}_{symb} | N^{frame,u}ₛₗₒₜ | N^{subframe,u}ₛₗₒₜ |
|---|---|---|---|
| 2 | 12 | 40 | 4 |

For an SCS configuration u, slots may be indexed within a subframe in ascending order as follows: n^{u}ₛ∈{0, . . . , n^{subframe,u}ₛₗₒₜ−1} and indexed within a frame in ascending order as follows: n^{u}_{s,f}∈{0, . . . , n^{frame,u}ₛₗₒₜ−1}.

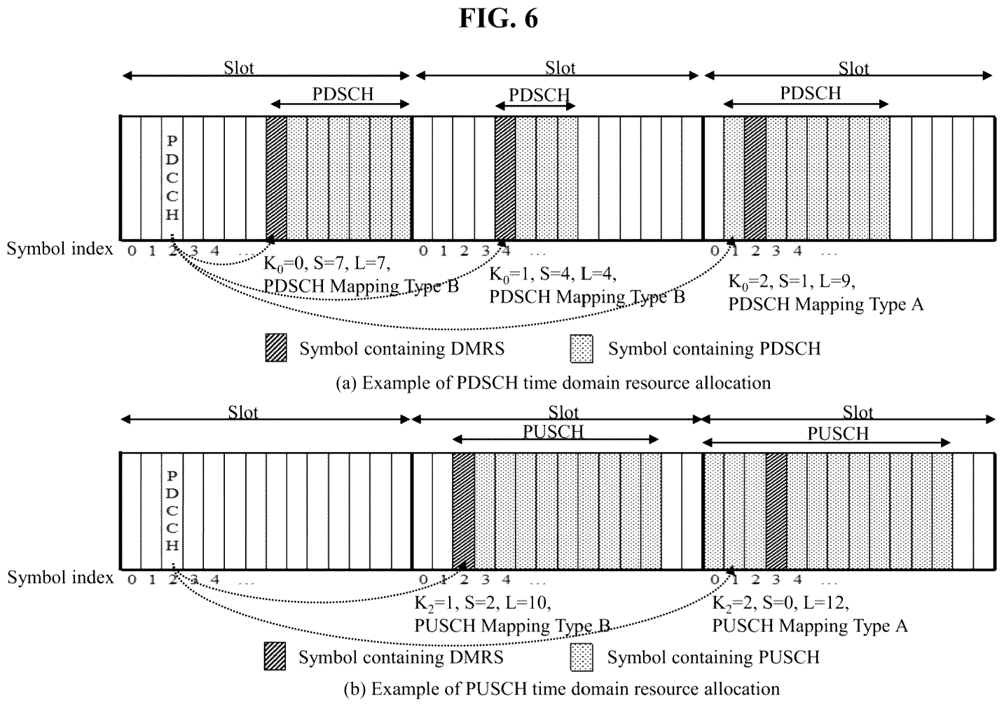

FIG. 5 illustrates a resource grid of a slot. The slot includes multiple (e.g., 14 or 12) symbols in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at a common resource block (CRB) N^{start,u}_{grid} indicated by higher layer signaling (e.g. RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP-based wireless communication system, N^{RB}_{sc} is typically 12. There is one resource grid for a given antenna port p, an SCS configuration u, and a transmission link (DL or UL). The carrier bandwidth N^{size,u}_{grid} for the SCS configuration u is given to the UE by a higher layer parameter (e.g. RRC parameter). Each element in the resource grid for the antenna port p and the SCS configuration u is referred to as a resource element (RE) and one complex symbol may be mapped to each RE. Each RE in the resource grid is uniquely identified by an index k in the frequency domain and an index l representing a symbol location relative to a reference point in the time domain. In the NR system, an RB is defined by 12 consecutive subcarriers in the frequency domain. In the NR system, RBs are classified into CRBs and physical resource blocks (PRBs). The CRBs are numbered from 0 upwards in the frequency domain for the SCS configuration u. The center of subcarrier 0 of CRB 0 for the SCS configuration u is equal to ‘Point A’ which serves as a common reference point for RB grids. The PRBs for subcarrier spacing configuration u are defined within a bandwidth part (BWP) and numbered from 0 to N^{size,u}_{BWP,i}−1, where i is a number of the BWP. The relation between a PRB n_{PRB} in a BWP i and a CRB n^{u}_{CRB} is given by: n^{u}_{PRB}=n^{u}_{CRB}+N^{size,u}_{BWP,i}, Where N^{size}_{BWP,i} is a CRB in which the BWP starts relative to CRB 0. The BWP includes a plurality of consecutive RBs in the frequency domain. For example, the BWP may be a subset of contiguous CRBs defined for a given numerology ui in the BWP i on a given carrier. A carrier may include a maximum of N (e.g., 5) BWPs. The UE may be configured to have one or more BWPs on a given component carrier. Data communication is performed through an activated BWP and only a predetermined number of BWPs (e.g., one BWP) among BWPs configured for the UE may be active on the component carrier.

For each serving cell in a set of DL BWPs or UL BWPs, the network may configure at least an initial DL BWP and one (if the serving cell is configured with uplink) or two (if supplementary uplink is used) initial UL BWPs. The network may configure additional UL and DL BWPs. For each DL BWP or UL BWP, the UE may be provided the following parameters for the serving cell: i) an SCS; ii) a CP: iii) a CRB N^{start}_{BWP}=O_{carrier}+RBₛₜₐᵣₜ and the number of contiguous RBs N^{size}_{BWP}=L_{RB} provided by an RRC parameter locationAndBandwidth, which indicates an offset RBₛₑₜ and a length L_{RB} as a resource indicator value (RIV) on the assumption of N^{start}_{BWP}=275, and a value O_{carrier} provided by an RRC parameter offsetToCarrier for the SCS: an index in the set of DL BWPs or UL BWPs: a set of BWP-common parameters; and a set of BWP-dedicated parameters.

Virtual resource blocks (VRBs) may be defined within the BWP and indexed from 0 to N^{size,u}_{BWP,i}−1, where i denotes a BWP number. The VRBs may be mapped to PRBs according to interleaved mapping or non-interleaved mapping. In some implementations, VRB n may be mapped to PRB n for non-interleaved VRB-to-PRB mapping.

NR frequency bands are defined as two types of frequency ranges, i.e., FR1 and FR2. FR2 is also referred to as millimeter wave (mmW). The following table shows frequency ranges within which NR may operate.

TABLE 3

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Hereinafter, physical channels that may be used in the 3GPP-based wireless communication system will be described in detail.

A PDCCH carries DCI. For example, the PDCCH (i.e., DCI) carries information about transport format and resource allocation of a downlink shared channel (DL-SCH), information about resource allocation of an uplink shared channel (UL-SCH), paging information about a paging channel (PCH), system information about the DL-SCH, information about resource allocation for a control message, such as a random access response (RAR) transmitted on a PDSCH, of a layer (hereinafter, higher layer) positioned higher than a physical layer among protocol stacks of the UE/BS, a transmit power control command, information about activation/deactivation of configured scheduling (CS), etc. DCI including resource allocation information on the DL-SCH is called PDSCH scheduling DCI, and DCI including resource allocation information on the UL-SCH is called PUSCH scheduling DCI. The DCI includes a cyclic redundancy check (CRC). The CRC is masked/scrambled with various identifiers (e.g., radio network temporary identifier (RNTI)) according to an owner or usage of the PDCCH. For example, if the PDCCH is for a specific UE, the CRS is masked with a UE identifier (e.g., cell-RNTI (C-RNTI)). If the PDCCH is for a paging message, the CRC is masked with a paging RNTI (P-RNTI). If the PDCCH is for system information (e.g., system information block (SIB)), the CRC is masked with a system information RNTI (SI-RNTI). If the PDCCH is for a random access response, the CRC is masked with a random access-RNTI (RA-RNTI).

When a PDCCH on one serving cell schedules a PDSCH or a PUSCH on another serving cell, it is referred to cross-carrier scheduling. Cross-carrier scheduling with a carrier indicator field (CIF) may allow a PDCCH on a serving cell to schedule resources on another serving cell. When a PDSCH on a serving cell schedules a PDSCH or a PUSCH on the serving cell, it is referred to as self-carrier scheduling. When the cross-carrier scheduling is used in a cell, the BS may provide information about a cell scheduling the cell to the UE. For example, the BS may inform the UE whether a serving cell is scheduled by a PDCCH on another (scheduling) cell or scheduled by the serving cell. If the serving cell is scheduled by the other (scheduling) cell, the BS may inform the UE which cell signals DL assignments and UL grants for the serving cell. In the present disclosure, a cell carrying a PDCCH is referred to as a scheduling cell, and a cell where transmission of a PUSCH or a PDSCH is scheduled by DCI included in the PDCCH, that is, a cell carrying the PUSCH or PDSCH scheduled by the PDCCH is referred to as a scheduled cell.

A PDSCH is a physical layer UL channel for UL data transport. The PDSCH carries DL data (e.g., DL-SCH transport block) and is subjected to modulation such as quadrature phase shift keying (QPSK), 16 quadrature amplitude modulation (QAM), 64 QAM, 256 QAM, etc. A codeword is generated by encoding a transport block (TB). The PDSCH may carry a maximum of two codewords. Scrambling and modulation mapping per codeword may be performed and modulation symbols generated from each codeword may be mapped to one or more layers. Each layer is mapped to a radio resource together with a DMRS and generated as an OFDM symbol signal. Then, the OFDM symbol signal is transmitted through a corresponding antenna port.

A PUCCH is a physical layer UL channel for uplink control information (UCI) transmission. The PUCCH carries UCI. UCI types transmitted on the PUCCH include hybrid automatic repeat request acknowledgement (HARQ-ACK) information, a scheduling request (SR), and channel state information (CSI). UCI bits include HARQ-ACK information bits if present, SR information bits if present, link recovery request (LRR) information bits if present, and CSI bits if present. In the present disclosure, HARQ-ACK information bits correspond to an HARQ-ACK codebook. In particular, a bit sequence in which HARQ-ACK information bits are arranged according to a predetermined rule is called an HARQ-ACK codebook.
Scheduling request (SR): Information that is used to request a UL-SCH resource.
Hybrid automatic repeat request (HARQ)—acknowledgment (ACK): A response to a DL data packet (e.g., codeword) on the PDSCH. HARQ-ACK indicates whether the DL data packet has been successfully received by a communication device. In response to a single codeword, 1-bit HARQ-ACK may be transmitted. In response to two codewords, 2-bit HARQ-ACK may be transmitted. The HARQ-ACK response includes positive ACK (simply, ACK), negative ACK (NACK), discontinuous transmission (DTX), or NACK/DTX. Here, the term HARQ-ACK is used interchangeably with HARQ ACK/NACK, ACK/NACK, or A/N.
Channel state information (CSI): Feedback information about a DL channel. The CSI may include channel quality information (CQI), a rank indicator (RI), a precoding matrix indicator (PMI), a CSI-RS resource indicator (CRI), an SS/PBCH resource block indicator (SSBRI), and a layer indicator (L1). The CSI may be classified into CSI part 1 and CSI part 2 according to UCI type included in the CSI. For example, the CRI, RI, and/or the CQI for the first codeword may be included in CSI part 1, and LI, PMI, and/or the CQI for the second codeword may be included in CSI part 2.
Link recovery request (LRR)

In the present disclosure, for convenience, PUCCH resources configured/indicated for/to the UE by the BS for HARQ-ACK, SR, and CSI transmission are referred to as an HARQ-ACK PUCCH resource, an SR PUCCH resource, and a CSI PUCCH resource, respectively.

PUCCH formats may be defined as follows according to UCI payload sizes and/or transmission lengths (e.g., the number of symbols included in PUCCH resources). The table below shows the PUCCH formats. The PUCCH formats may be divided into short PUCCH formats (formats 0 and 2) and long PUCCH formats (formats 1, 3, and 4) according to PUCCH transmission length.

TABLE 4

| | Length in | | | |
|---|---|---|---|---|
| | OFDM | | | |
| PUCCH | symbols | Number | | |
| format | N^{PUCCH}_{symb} | of bits | Usage | Etc. |
| 0 | 1-2 | =<2 | HARQ, SR | Sequence selection |
| 1 | 4-14 | =<2 | HARQ, [SR] | Sequence modulation |
| 2 | 1-2 | >2 | HARQ, CSI, [SR] | CP-OFDM |
| 3 | 4-14 | >2 | HARQ, CSI, [SR] | DFT-s-OFDM(no UE |
| | | | | multiplexing) |
| 4 | 4-14 | >2 | HARQ, CSI, [SR] | DFT-s-OFDM(Pre |
| | | | | DFT OCC) |

A PUCCH resource may be determined according to a UCI type (e.g., A/N, SR, or CSI). A PUCCH resource used for UCI transmission may be determined based on a UCI (payload) size. For example, the BS may configure a plurality of PUCCH resource sets for the UE, and the UE may select a specific PUCCH resource set corresponding to a specific range according to the range of the UCI (payload) size (e.g., numbers of UCI bits). For example, the UE may select one of the following PUCCH resource sets according to the number of UCI bits, N_{UCI}.
PUCCH resource set #0, if the number of UCI bits=<2
PUCCH resource set #1, if 2<the number of UCI bits=<N₁
. . .
PUCCH resource set #(K−1), if N_{K-2}<the number of UCI bits=<N_{K-1}

Here, K represents the number of PUCCH resource sets (K>1) and Nᵢ represents a maximum number of UCI bits supported by PUCCH resource set #i. For example, PUCCH resource set #1 may include resources of PUCCH formats 0 to 1, and the other PUCCH resource sets may include resources of PUCCH formats 2 to 4 (see Table 4).

Configuration for each PUCCH resource includes a PUCCH resource index, a start PRB index, and configuration for one of PUCCH format 0 to PUCCH format 4. The UE is configured with a code rate for multiplexing HARQ-ACK, SR, and CSI report(s) within PUCCH transmission using PUCCH format 2, PUCCH format 3, or PUCCH format 4, by the BS through a higher layer parameter maxCodeRate. The higher layer parameter maxCodeRate is used to determine how to feed back the UCI on PUCCH resources for PUCCH format 2, 3, or 4.

If the UCI type is SR and CSI, a PUCCH resource to be used for UCI transmission in a PUCCH resource set may be configured for the UE through higher layer signaling (e.g., RRC signaling). If the UCI type is HARQ-ACK for a semi-persistent scheduling (SPS) PDSCH, the PUCCH resource to be used for UCI transmission in the PUCCH resource set may be configured for the UE through higher layer signaling (e.g., RRC signaling). On the other hand, if the UCI type is HARQ-ACK for a PDSCH scheduled by DCI, the PUCCH resource to be used for UCI transmission in the PUCCH resource set may be scheduled by the DCI.

In the case of DCI-based PUCCH resource scheduling, the BS may transmit the DCI to the UE on a PDCCH and indicate a PUCCH resource to be used for UCI transmission in a specific PUCCH resource set by an ACK/NACK resource indicator (ARI) in the DCI. The ARI may be used to indicate a PUCCH resource for ACK/NACK transmission and also be referred to as a PUCCH resource indicator (PRI). Here, the DCI may be used for PDSCH scheduling and the UCI may include HARQ-ACK for a PDSCH. The BS may configure a PUCCH resource set including a larger number of PUCCH resources than states representable by the ARI by (UE-specific) higher layer (e.g., RRC) signaling for the UE. The ARI may indicate a PUCCH resource subset of the PUCCH resource set and which PUCCH resource in the indicated PUCCH resource subset is to be used may be determined according to an implicit rule based on transmission resource information about the PDCCH (e.g., the starting CCE index of the PDCCH).

For UL-SCH data transmission, the UE should include UL resources available for the UE and, for DL-SCH data reception, the UE should include DL resources available for the UE. The UL resources and the DL resources are assigned to the UE by the BS through resource allocation. Resource allocation may include time domain resource allocation (TDRA) and frequency domain resource allocation (FDRA). In the present disclosure, UL resource allocation is also referred to as a UL grant and DL resource allocation is referred to as DL assignment. The UL grant is dynamically received by the UE on the PDCCH or in RAR or semi-persistently configured for the UE by the BS through RRC signaling. DL assignment is dynamically received by the UE on the PDCCH or semi-persistently configured for the UE by the BS through RRC signaling.

On UL, the BS may dynamically allocate UL resources to the UE through PDCCH(s) addressed to a cell radio network temporary Identifier (C-RNTI). The UE monitors the PDCCH(s) in order to discover possible UL grant(s) for UL transmission. The BS may allocate the UL resources using a configured grant to the UE. Two types of configured grants, Type 1 and Type 2, may be used. In Type 1, the BS directly provides the configured UL grant (including periodicity) through RRC signaling. In Type 2, the BS may configure a periodicity of an RRC-configured UL grant through RRC signaling and signal, activate, or deactivate the configured UL grant through the PDCCH addressed to a configured scheduling RNTI (CS-RNTI). For example, in Type 2, the PDCCH addressed to the CS-RNTI indicates that the corresponding UL grant may be implicitly reused according to the configured periodicity through RRC signaling until deactivation.

On DL, the BS may dynamically allocate DL resources to the UE through PDCCH(s) addressed to the C-RNTI. The UE monitors the PDCCH(s) in order to discover possible DL grant(s). The BS may allocate the DL resources to the UE using SPS. The BS may configure a periodicity of configured DL assignment through RRC signaling and signal, activate, or deactivate the configured DL assignment through the PDCCH addressed to the CS-RNTI. For example, the PDCCH addressed to the CS-RNTI indicates that the corresponding DL assignment may be implicitly reused according to the configured periodicity through RRC signaling until deactivation.

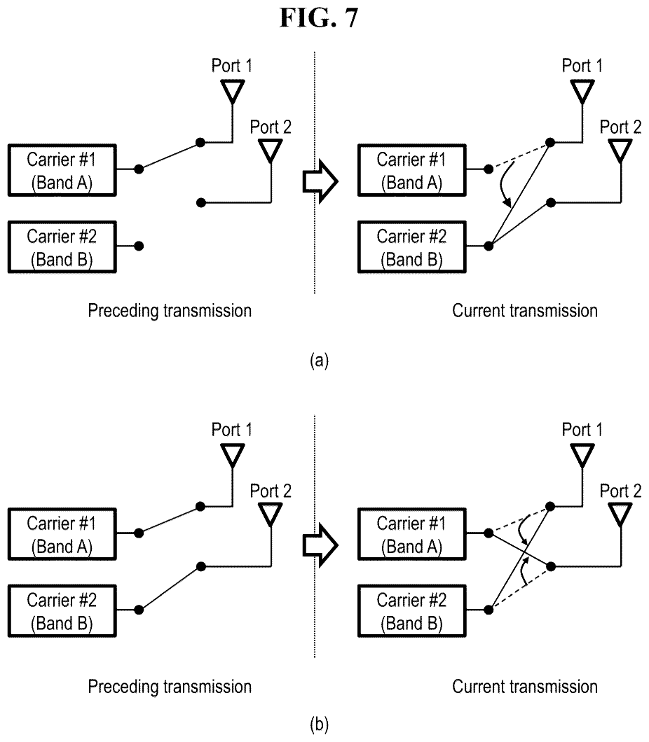

FIG. 6 illustrates an example of PDSCH TDRA caused by a PDCCH and an example of PUSCH TDRA caused by the PDCCH.

DCI carried by the PDCCH in order to schedule a PDSCH or a PUSCH includes a TDRA field. The TDRA field provides a value m for a row index m+1 to an allocation table for the PDSCH or the PUSCH. Predefined default PDSCH time domain allocation is applied as the allocation table for the PDSCH or a PDSCH TDRA table that the BS configures through RRC signaled pdsch-TimeDomainAllocationList is applied as the allocation table for the PDSCH. Predefined default PUSCH time domain allocation is applied as the allocation table for the PUSCH or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214).

In PDSCH time domain resource configurations, each indexed row defines a DL assignment-to-PDSCH slot offset K₀, a start and length indicator value SLIV (or directly, a start position (e.g., starting symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., starting symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the starting symbol S relative to the start of the slot with the PDSCH or PUSCH and the number of consecutive symbols, L, counting from the symbol S. There are two PDSCH/PUSCH mapping types: one is mapping type A and the other is mapping type B. In the case of PDSCH/PUSCH mapping type A, a DMRS is mapped to a PDSCH/PUSCH resource with respect to the start of a slot. One or two of the symbols of the PDSCH/PUSCH resource may be used as DMRS symbol(s) according to other DMRS parameters. For example, in the case of PDSCH/PUSCH mapping type A, the DMRS is located in the third symbol (symbol #2) or the fourth symbol (symbol #3) in the slot according to RRC signaling. In the case of PDSCH/PUSCH mapping type B, a DMRS is mapped with respect to the first OFDM symbol of a PDSCH/PUSCH resource. One or two symbols from the first symbol of the PDSCH/PUSCH resource may be used as DMRS symbol(s) according to other DMRS parameters. For example, in the case of PDSCH/PUSCH mapping type B, the DMRS is located at the first symbol allocated for the PDSCH/PUSCH. In the present disclosure, the PDSCH/PUSCH mapping type may be referred to as a mapping type or a DMRS mapping type. For example, in the present disclosure, PUSCH mapping type A may be referred to as mapping type A or DMRS mapping type A, and PUSCH mapping type B may be referred to as mapping type B or DMRS mapping type B.

The scheduling DCI includes an FDRA field that provides assignment information about RBs used for the PDSCH or the PUSCH. For example, the FDRA field provides information about a cell for PDSCH or PUSCH transmission to the UE, information about a BWP for PDSCH or PUSCH transmission, and/or information about RBs for PDSCH or PUSCH transmission.

In the present disclosure, a PDSCH based on DL SPS may be referred to as an SPS PDSCH, and a PUSCH based on a UL configured grant (CG) may be referred to as a CG PUSCH. A PDSCH dynamically scheduled by DCI carried on a PDCCH may be referred to as a dynamic grant (DG) PDSCH, and a PUSCH dynamically scheduled by DCI carried by on a PDCCH may be referred to as a DG PUSCH.

A PDCCH is transmitted through a control resource set (CORESET). One or more CORESETs may be configured for the UE. The CORESET consists of a set of PRBs with a duration of 1 to 3 OFDM symbols. The PRBs and a CORESET duration that constitute the CORESET may be provided to the UE through higher layer (e.g., RRC) signaling. A set of PDCCH candidates in the configured CORESET(s) is monitored according to corresponding search space sets. In the present disclosure, monitoring implies decoding (called blind decoding) each PDCCH candidate according to monitored DCI formats. A master information block (MIB) on a PBCH provides parameters (e.g., CORESET #0 configuration) for monitoring a PDCCH for scheduling a PDSCH carrying system information block 1 (SIB1) to the UE. The PBCH may also indicate that there is no associated SIB1. In this case, the UE may be provided with not only a frequency range in which the UE may assume that there is no SSB associated with SSB1 but also other frequencies to search for an SSB associated with SIB1. CORESET #0, which is a CORESET for scheduling SIB1 at least, may be configured by the MIB or dedicated RRC signaling.

A set of PDCCH candidates monitored by the UE is defined in terms of PDCCH search space sets. The search space set may be a common search space (CSS) set or a UE-specific search space (USS) set. Each CORESET configuration is associated with one or more search space sets, and each search space set is associated with one CORESET configuration. The following table illustrates a DCI format that the PDCCH may carry.

TABLE 5

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the |
| | PRB(s) and OFDM symbol(s) |
| | where UE may assume no transmission |
| | is intended for the UE |
| 2_2 | Transmission of TPC commands for |
| | PUCCH and PUSCH |
| 2_3 | Transmission of a group of TPC commands |
| | for SRS transmissions by one or more UEs |
| 2_4 | Notifying a group of UEs of PRB(s) |
| | and OFDM symbol(s) where |
| | UE cancels the corresponding |
| | UL transmission from the UE |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH. For a CSS, DCI format 0_0 and DCI format 1_0 have fixed sizes after the BWP size is initially given by RRC. For a USS, DCI format 0_0 and DCI format 1_0 are fixed in size in fields other than a frequency domain resource assignment (FDRA) field, and the FDRA field may vary in size by configuration of a related parameter by the BS. In DCI format 0_1 and DCI format 1_1, the size of the DCI field may be changed by various RRC reconfigurations by the BS. DCI format 2_0 may be used to provide dynamic slot format information (e.g., SFI DCI) to the UE, DCI format 2_1 may be used to provide DL pre-emption information to the UE, and DCI format 2_4 may be used to indicate a UL resource on which the UE needs to cancel UL transmission.

In general, regarding a UE, the number of antennas that can be installed in the corresponding UE is limited due to its size. A UE with N transmission chains through N antennas may simultaneously support up to N 1-port UL transmissions or support up to a maximum N-port UL transmission. There is a need for a plan for supporting a UE having a limited transmission chain to effectively perform a UL transmission. Hereinafter, implementations of the present disclosure relating to UL transmission (Tx) switching are described. Since most UEs developed up to date support up to two Tx chains, implementations of the present disclosure are described below as the premise that a UE supports up to two Tx chains, i.e., a UL transmission through maximum two ports. However, implementations of the present disclosure are not limited to a 1- or 2-port UL transmission, and may also be applied to an N-port UL transmission, where N may be greater than 2.

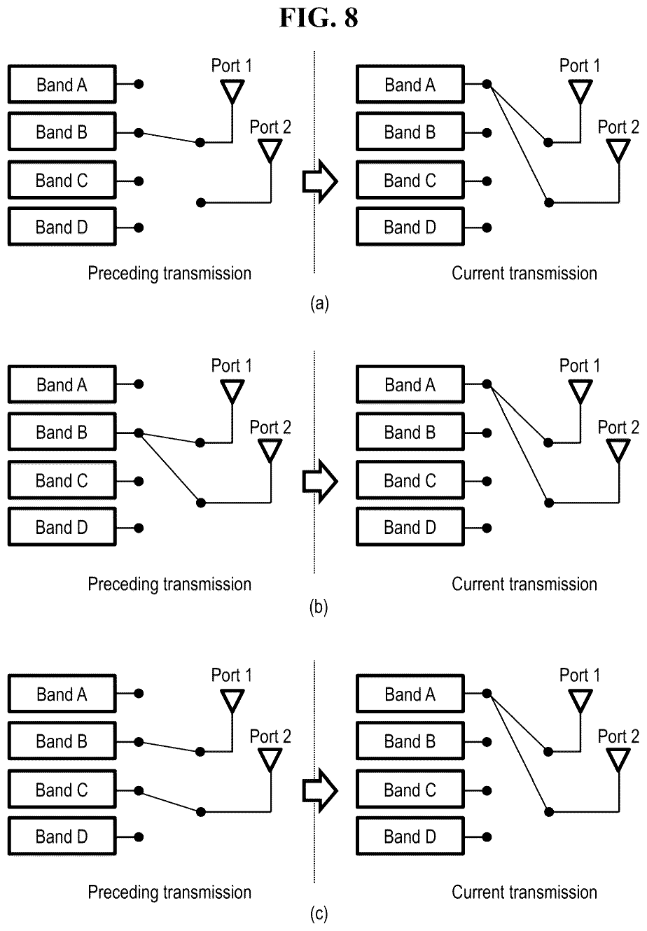

FIG. 7 is a diagram illustrating the concept of uplink transmission switching.

In order to increase throughput and efficiency of a UL transmission, in NR Rel-16 for the purpose of enabling a UE to effectively perform a 1-port UL transmission or a 2-port UL transmission using maximum two Tx chains, UL Tx Switching (UTS) for switching Tx chain(s) connected to UL carrier(s) under a specific condition has been defined. FIG. 7 (a) illustrates 1Tx-2Tx switching between two carriers/bands, and FIG. 7 (b) illustrates 2Tx-2Tx switching between two carriers/bands.

For example, after a UL transmission (hereinafter, previous transmission) has been performed with 1 Tx chain on carrier #1, when it is configured/indicated to perform a UL transmission (hereinafter, a current transmission) through 2 Tx chain on another carrier #2, a UE may switch the Tx chain previously connected to the carrier #1 to the carrier #2 so that a 2-port UL transmission is possible on the carrier #2. Such a UTS configuration and switching method may be applied to a band combination corresponding to Evolved-Universal Terrestrial Radio Access-New-Radio-Dual Connectivity (EN-DC) without a Supplementary UL (SUL), a standalone SUL, and an inter-band CA. In NR Rel-17, additional conditions have been introduced to extend the 1Tx-2Tx switching (i.e., switching between 1 Tx chain and 2 Tx chain) of the existing NR Rel-6 to the 2Tx-2Tx switching (i.e., switching between 2 Tx chain and 2 Tx chain), and at the same time, UTS between two carriers introduced in NR Rel-16 can be performed between two bands different from each other (e.g., between one carrier in one band and two contiguous carriers in the other band).

If specific conditions are met and a UE is configured as uplinkTxSwitching via RRC signaling, the UE may omit a UL transmission during an uplink switching gap NTx1-Tx2. For example, if specific conditions are met and a UE is configured as uplinkTxSwitching via RRC signaling, the UE omits all UL transmission(s) including a UL transmission scheduled via DCI and a UL transmission (e.g. configured grant based PUSCH) configured by higher layer signaling during an uplink switching gap NTx1-Tx2. The switching gap NTx1-Tx2 may be indicated by uplinkTxSwitchingPeriod2T2T provided to a BS from the UE through a UE capability report when uplinkTxSwitching-2T-Mode is configured through RRC signaling, or may be indicated by uplinkTxSwitchingPeriod provided to the BS from the UE through the UE capability report otherwise. Here, the RRC configuration uplinkTxSwitching may be provided to the UE in a manner of being included in the configuration on a serving cell, and may include uplinkTxSwitchingPeriodLocation indicating whether a location of a UL TX switching period is configured in this UL carrier in the case of inter-band UL CA, SUL, or (NG) EN-DC and uplinkTxSwitchingCarrier indicating that the configured carrier is carrier 1 or carrier 2 for dynamic UL Tx Switching. The RRC parameter uplinkTxSwitching-2T-Mode indicates that the 2Tx-2Tx switching mode is configured for the inter-band UL CA or SUL. In this case, the switching gap duration for the triggered UL switching may be the same as a switching time capability value reported for the switching mode. If the RRC parameter uplinkTxSwitching-2T-Mode is not provided and uplinkTxSwitching is configured, it may be interpreted that 1Tx-2Tx UTS is configured. In this case, there may be a single uplink configured as uplinkTxSwitching (or a single uplink band in case of the intra-band).

If the UE has indicated the capability for uplink switching for the band combination, if it is for that band combination configured with an MCG using E-UTRA radio access, with an SCG using NR radio access, or with an uplink CA, or if 2 UL carriers are configured with a higher layer (e.g., RRC) parameter supplementaryUplink in a serving cell having two UL carriers, the switching gap may be present under specific conditions. For example, the following tables are excerpt from 3GPP TS 38.214 V17.1.0, which illustrates UTS conditions.

If the uplink switching is triggered for an uplink transmission starting at T₀, which is after T₀−T_{offset}, the UE is not expected to cancel the uplink switching or to trigger any other new uplink switching that occurs before T₀ for any other uplink transmission that is scheduled after T₀−T_{offset}. Here, T_{offset} may be a UE processing procedure time defined for an uplink transmission that triggers the switching (e.g. S5.3, S5.4, S6.2.1, and S6.4 of 3GPP TS 38.214 & S9 of 3GPP TS 38.213). The UE does not expect to perform more than one uplink switching in a slot that is u_{UL}=max (u_{UL,1}, U_{UL,2}), where u_{UL,1} corresponds to a subcarrier spacing of an active UL BWP of one uplink carrier before the switching gap, and U_{UL,2} corresponds to a subcarrier spacing of an active UL BWP of another uplink carrier after the switching gap.

TABLE 6

```
6.1.6.1 Uplink switching for EN-DC
For a UE indicating a capability for uplink switching with BandCombination-
UplinkTxSwitch for a band combination, and if it is for that band combination configured
with a MCG using E-UTRA radio access and with a SCG using NR radio access (EN-DC),
if the UE is configured with uplink switching with parameter uplinkTxSwitching,
  - for the UE configured with switchedUL by the parameter uplinkTxSwitchingOption,
      when the UE is to transmit in the uplink based on DCI(s) received before T₀ −
      T_{offset} or based on a higher layer configuration(s):
      - when the UE is to transmit an NR uplink that takes place after an E-UTRA uplink
        on another uplink carrier then the UE is not expected to transmit for the duration
        of N_{Tx1-Tx2} on any of the two carriers.
      - when the UE is to transmit an E-UTRA uplink that takes place after an NR uplink
        on another uplink carrier then the UE is not expected to transmit for the duration
        of N_{Tx1-Tx2} on any of the two carriers.
      - the UE is not expected to transmit simultaneously on the NR uplink and the E-
        UTRA uplink. If the UE is scheduled or configured to transmit any NR uplink
        transmission overlapping with an E-UTRA uplink transmission, the NR uplink
        transmission is dropped,
  - for the UE configured with uplinkTxSwitchingOption set to ‘dualUL’, when the UE is
      to transmit in the uplink based on DCI(s) received before T₀ − T_{offset} or based on a
      higher layer configuration(s):
      - when the UE is to transmit an NR two-port uplink that takes place after an E-
        UTRA uplink on another uplink carrier then the UE is not expected to transmit for
        the duration of N_{Tx1-Tx2} on any of the two carriers.
      - when the UE is to transmit an E-UTRA uplink that takes place after an NR two-
        port uplink on another uplink carrier then the UE is not expected to transmit for
        the duration of N_{Tx1-Tx2} on any of the two carriers.
      - the UE is not expected to transmit simultaneously a two-port transmission on the
        NR uplink and the E-UTRA uplink.
  - in all other cases the UE is expected to transmit normally all uplink transmissions
        without interruptions.
  - when the UE is configured with tdm-PatternConfig or by tdm-PatternConfig2
      - for the E-UTRA subframes designated as uplink by the configuration, the UE
        assumes the operation state in which one-port E-UTRA uplink can be transmitted.
      - for the E-UTRA subframes other than the ones designated as uplink by the
        configuration, the UE assumes the operation state in which two-port NR uplink
        can be transmitted.
```

TABLE 7

```
6.1.6.2 Uplink switching for carrier aggregation
For a UE indicating a capability for uplink switching with BandCombination-
UplinkTxSwitch or uplinkTxSwitchingPeriod2T2T for a band combination, and if it is for
that band combination configured with uplink carrier aggregation:
  - If the UE is configured with uplink switching with parameter uplinkTxSwitching,
      when the UE is to transmit in the uplink based on DCI(s) received before T₀ −
      T_{offset} or based on a higher layer configuration(s):
      - When the UE is to transmit a 2-port transmission on one uplink carrier on one
        band and if the preceding uplink transmission is a 1-port transmission on another
        uplink carrier on another band, then the UE is not expected to transmit for the
        duration of N_{Tx1-Tx2} on any of the carriers.
      - When the UE is to transmit a 1-port transmission on one uplink carrier on one
        band and if the preceding uplink transmission is a 2-port transmission on another
        uplink carrier on another band, then the UE is not expected to transmit for the
        duration of N_{Tx1-Tx2} on any of the carriers.
      - For the UE configured with uplinkTxSwitchingOption set to ‘switchedUL’, when
        the UE is to transmit a 1-port transmission on one uplink carrier on one band and
        if the preceding uplink transmission was a 1-port transmission on another uplink
        carrier on another band, then the UE is not expected to transmit for the duration of
        N_{Tx1-Tx2} on any of the carriers.
      - For the UE configured with uplinkTxSwitchingOption set to ‘dualUL’, when the
        UE is to transmit a 2-port transmission on one uplink carrier on one band and if
        the preceding uplink transmission was a 1-port transmission on a carrier on the
        same band and the UE is under the operation state in which 2-port transmission
        cannot be supported in the same band, then the UE is not expected to transmit for
        the duration of N_{Tx1-Tx2} on any of the carriers.
      - For the UE configured with uplinkTxSwitchingOption set to ‘dualUL’, when the
        UE is to transmit a 1-port transmission on one uplink carrier on one band and if
        the preceding uplink transmission was a 1-port transmission on another uplink
        carrier on another band and the UE is under the operation state in which 2-port
        transmission can be supported on the same uplink carrier, then the UE is not
        expected to transmit for the duration of N_{Tx1-Tx2} on any of the carriers.
      - For the UE configured with uplinkTxSwitchingOption set to ‘dualUL’, if the UE is
        configured with OneT with uplinkTxSwitching-DualUL-TxState, when the UE is
        under the operation state in which 2-port transmission can be supported on one
        carrier on one band followed by no transmission on any carrier on the same band
        and 1-port transmission on the other carrier on another band the UE shall consider
        this as if 1-port transmission was transmitted on both uplinks, otherwise the UE
        shall consider this as if 2-port transmission took place on the transmitting carrier.
      - If uplinkTxSwitching-2T-Mode is configured, when the UE is to transmit a 2-port
        transmission on one uplink carrier on one band and if the preceding uplink
        transmission is a 2-port transmission on another uplink carrier on another band,
        then the UE is not expected to transmit for the duration of N_{Tx1-Tx2} on any of the
        carriers.
      - The UE is not expected to be scheduled or configured with uplink transmissions
        that result in simultaneous transmission on two antenna ports on one uplink carrier
        on one band, and any transmission on another uplink carrier on another band.
  - In all other cases the UE is expected to transmit normally all uplink transmissions
      without interruptions.
```

TABLE 8

```
6.1.6.3 Uplink switching for supplementary uplink
For a UE indicating a capability for uplink switching with BandCombination-
UplinkTxSwitch for a band combination, and if it is for that band combination configured
in a serving cell with two uplink carriers with higher layer parameter supplementaryUplink:
  - If the UE is configured with uplink switching with parameter uplinkTxSwitching,
      - If the UE is to transmit any uplink channel or signal on a different uplink on a
        different band from the preceding transmission occasion based on DCI(s) received
        before T₀ − T_{offset} or based on a higher layer configuration(s), then the UE
        assumes that an uplink switching is triggered in a duration of switching gap
        N_{Tx1-Tx2}, where T₀ is the start time of the first symbol of the transmission
        occasion of the uplink channel or signal and T_{offset} is the preparation procedure
        time of the transmission occasion of the uplink channel or signal given in clause
        5.3, clause 5.4, clause 6.2.1, clause 6.4 and in clause 9 of [6, TS 38.213],
        respectively. During the switching gap N_{Tx1-Tx2}, the UE is not expected to
        transmit on any of the two uplinks.
  - In all other cases the UE is expected to transmit normally all uplink transmissions
      without interruptions.
```

NR supports a wide range of spectra in various frequency ranges. Owing to the rearrangement of the band originally used in the previous cellular generation network, the availability of the spectrum is expected to increase in the 5G advanced market. In particular, in the case of a low-frequency FR1 band, an available spectrum block tends to be further subdivided and distributed to a narrower bandwidth. In the case of an FR2 band and a partial FR1 band, the available spectrum may be wider, and thus an in-band multi-carrier operation is required. To meet various spectral requirements, it is important to utilize this distributed spectrum band or wider bandwidth spectrum in a more spectrum/power efficient and flexible manner to provide higher throughput and appropriate coverage in a network. In the case of a multi-carrier UL operation, there are several limitations in the current specification. For example, a 2Tx UE may be configured with up to two UL bands that are changeable only by RRC reconfiguration, and UL Tx switching may be performed only between two UL subbands for the 2Tx UE. Instead of RRC-based cell(s) reconfiguration, based on, for example, data traffic, TDD DL/UL configuration, bandwidth, and channel conditions of the respective bands, dynamically selecting carriers with UL Tx switching may potentially lead to higher UL data rate, spectrum utilization, and UE capacity,.

For the higher UL specification data rate, spectrum utilization, and UE capacity, UTS between more than two bands is being considered. Hereinafter, UTS trigger condition(s), UTS related configuration method(s), and/or UTS operation method(s) needed to support UTS between a plurality of bands (e.g. three or more bands) are described according to some implementations of the present disclosure.

Hereinafter, a cell may be interpreted depending on context. For example, a cell may mean a serving cell. In addition, a cell may include one DL Component Carrier (CC) and 0 to 2 UL CCs, but the implementations of the present disclosure to be described below are not limited thereto. Hereinafter, when there is no separate distinction, terms “cell” and “CC” may be used interchangeably. In addition, in some implementations of the present disclosure, a cell/CC may be applied in a manner of being substituted with a (active) BWP in a serving cell. In addition, unless specified otherwise, in the implementations of the present disclosure to be described below, a cell/CC may be used as a concept encompassing PCell, SCell, PsCell, etc., which may be configured/represented in a Carrier Aggregation/Dual Connectivity (CA/DC) scenario.

Hereinafter, “band” refers to a frequency band, and the term “band” may be used interchangeably with the term “carrier” and/or “cell” in the band. In this case, each band may be composed of one carrier or multiple (e.g., two) contiguous (or non-contiguous) carriers. The proposed methods described below may also be applied to inter-band UL CA, intra-band UL CA, NR-DC, EN-DC, (standalone) SUL scenario, and band combinations associated therewith (as long as there is no separate constraint).

In the implementations of the present disclosure described below, the following notation is used for convenience of description.
A case of an occurrence of UTS may be expressed as being UTS-triggered.
A band (or carrier) associated with UTS: may mean a band/carrier before and after UTS occurrence
A Tx chain transition time occurring due to UTS is referred to as a UTS gap (or a UTS period). A UL transmission is not performed in a band/carrier associated with the UTS during the UTS gap.
1 Tx chain may be expressed as 1T, and 2 Tx chain may be expressed as 2T.
1-port UL transmission may be expressed as 1p, and 2-port UL transmission may be expressed as 2p.
. If 1 Tx chain or 2 Tx chain is connected to a specific band A (and/or carrier(s) belonging to the band A), this state may be expressed as A(1T) and A(2T), respectively.
If 1 Tx chain is connected to each of two specific band A (and/or carrier(s) belonging to the band A) and band B (and/or carrier(s) belonging to the band B), this state may be expressed as A(1T)+B(1T).
A UL transmission may mean a random (any) UL channel or UL signal supported by NR and the like.
“Previous transmission” may mean the most recent UL transmission performed by a corresponding UE before the UTS triggering, and “current transmission” may mean a UL transmission performed by the corresponding UE immediately after the UTS triggering (or simultaneously). In addition, hereinafter, the expression “transmission” may mean “UL transmission”.
An expression that a UL transmission has occurred may mean a UL transmission scheduled through DCI for UL grant and/or a UL transmission (e.g. a configured grant UL transmission) configured through higher layer signaling (e.g. RRC signaling).
If a 1-port UL transmission occurs in a specific band A (and/or carrier(s) belonging to the band A), it may be expressed as A(1P), and if a 2-port UL transmission occurs, it may be expressed as A(2P).
When a 1-port UL transmission occurs in each of two specific bands, for example, band A and band B, (and/or carrier(s) belonging to the corresponding band), it may be expressed as A(1p)+B(1p).

Some implementations of the present disclosure described below are described in terms of focus on the occurrence of UTS between two bands in a situation where four bands/carriers are configured (or activated). However, the same method(s) as those of the present disclosure to be described below may be applied to the UTS occurring when a smaller number (e.g., 3) of bands are configured/activated. In addition, the same method(s) as those of the present disclosure, which will be described later, may be applied to UTS occurring in a situation where a larger number (e.g., 5) of bands are configured/activated.

Some implementations of the present disclosure described below are described without distinguishing between 1Tx-2Tx switching or 2Tx-2Tx switching. However, some implementations may be typically applicable to 1Tx-2Tx switching and/or 2Tx-2Tx switching.

In some implementations of the present disclosure described below, occurrence of “simultaneous transmission” in a plurality of bands may mean a case that a start time (e.g., a start symbol) of a UL transmission in each of a plurality of the bands coincides and/or a case that a portion (or all) of a UL transmission resource/period in each of a plurality of the bands overlaps in time.

If a BS knows that Tx chain(s) of a UE is (are) connected to which band(s)/carrier(s), it may also know a UTS gap in which the UE omits UL transmission(s) and may perform scheduling in consideration of the UTS gap (or it may recognize that DL interruption and/or UL interruption may occur during the UTS gap). If UTS is performed, since the band(s)/carrier(s) having the Tx chain(s) of the UE connected thereto are changed, the BS and the UE need to know the conditions for triggering the UTS. The UTS triggering conditions illustrated in Tables 6 to 8 are for switching Tx chain(s) between two carriers or two bands. UTS triggering condition(s) need to be defined in consideration of UTS between two or more bands.

Hereinafter, some implementations of the present disclosure regarding UTS triggering condition(s) will be described. UTS triggering conditions #1 to #5 described below may be applied alone or together with two or more.

### Implementation 1) UTS Triggering Condition #1

A UE may be configured such that 1 Tx chain is connected to two specific bands (or (two) bands corresponding to a specific Band Combination (BC)), and whether simultaneous UL transmission is possible in the corresponding two bands may be configured for the UE by RRC (e.g. uplinkTxSwitchingOption). The RRC parameter uplinkTxSwitchingOption provided to the UE by a BS may indicate which option is configured for dynamic UL Tx Switching for inter-band UL CA or (NG) EN-DC. This RRC parameter is set to swtichedUL if the network configures OPTION1, or set to dualUL if the network configures OPTION2. When the UE is configured with the corresponding RRC value set to “switchedUL”, the UE does not expect/perform that 1 Tx chain will be connected to each of the corresponding two bands, or does not expect/perform simultaneous transmissions (indication/configuration) in the corresponding two bands even though 1 Tx chain is connected thereto. Hereinafter, this is expressed as an OPTION1 operation is configured. For example, the UE that is configured with switchedUL does not expect that simultaneous transmissions of A(1T) and B(1T) will be indicated/configured, and the BS will not indicate/configure simultaneous transmissions of A(1T) and B(1T) to the UE. If the UE is configured with the corresponding RRC value set to “dualUL”, the UE may expect to be scheduled/configured with the simultaneous transmissions in the corresponding two bands through the 1 Tx chains connected to the corresponding two bands, respectively (or perform the corresponding simultaneous transmissions), which is expressed in the following description as OPTION2 operation is configured.

In some scenarios (e.g., NR Rel-16, NR Rel-17), a UE may report capability for Option1 or Option2 in units of BCs, and the BS may configure one of them to the UE by RRC. For example, referring to the Rel-17 document of 3GPP TS 38.331, a UE may set a UTS option supported by the UE to one of {switched, dualUL, both} for a BC and report it to the BS. The BS may provide the UE with a UTS option (uplinkTxSwitchingOption) through an RRC configuration cellGroupConfig.

Hereinafter, while three bands (hereinafter, denoted by band A, band B, and band C,) or four bands (hereinafter, denoted by band A, band B, band C, and band D) are configured and activated for a UE, conditions under which UTS may occur between two different bands among them are described. If one of the following conditions is met for a previous transmission and a current transmission of a UE, the UE may trigger UTS in a band where the current transmission occurs and/or in another band where the previous transmission occurred. In addition, the UE may expect that a UTS gap exists in at least one of the two bands, and that a UL transmission does not occur in the corresponding (two) bands (and carrier(s) within the corresponding band(s)) during a corresponding UTS gap period. For convenience, a band in which a current transmission (1p or 2p) occurs is described as band A. If a current transmission of 1p occurs on each of two different bands, the two bands on which the current transmission occurs are referred to as band A and band B for convenience. In addition, an actual transmission start timing point of a scheduled/configured current transmission (i.e., a start timing point of a first symbol of an actual UL transmission) is denoted by T₀, and a preparation time required for the corresponding UL transmission (e.g., a minimum time guaranteed from a DCI reception to an actual PUSCH transmission when a PUSCH transmission is scheduled through a DCI) is denoted by T_{offset}. A timing point at which the UE may determine whether UTS triggering is required due to the current transmission is denoted by T_j. In other words, the UE may not determine whether UTS triggering is required after the corresponding timing point T_j. In consideration of such a UE operation, a BS may have to select an appropriate UTS triggering timing point. In some implementations, T_j may be T₀, or any/specific timing point between T_offset or (T₀−T_{offset}) and T₀.

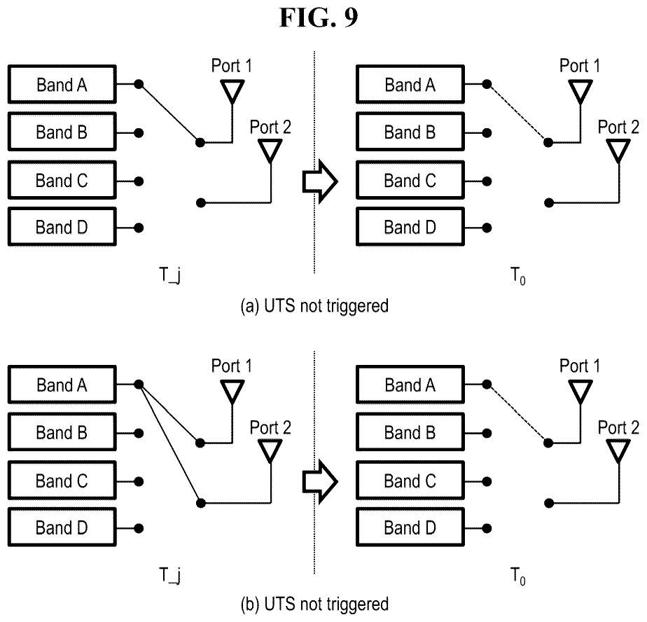

FIGS. 8 to 10 illustrate UTS triggering condition(s) or condition(s) for not triggering UTS according to some implementations of the present disclosure. In particular, FIG. 8 is provided to explain UTS triggering condition(s) according to some implementations of the present disclosure for a case where a current transmission is A(2p), FIG. 9 is provided to explain UTS triggering condition(s) according to some implementations of the present disclosure for a case where a current transmission is A(1p), and FIG. 10 is provided to explain UTS triggering condition(s) according to some implementations of the present disclosure for a case where a current transmission is A(1p)+B(1p).
>When A(2p) occurs as a current transmission,
>>Condition-1: If a previous transmission was in a band(s) other than band A, UTS may be triggered. In this case, the previous transmission may be 1p or 2p. For example, the corresponding previous transmission through which UTS may be triggered may be one of the following.
>>B(1p), B(2p), C(1p), C(2p), D(1p), D(2p), B(1p)+C(1p), B(1p)+D(1p), C(1p)+D(1p). FIGS. 8(a), 8(b), and 8(c) respectively illustrate cases in which previous transmissions are B(1p), B(2p), and B(1p)+C (1p), respectively. If only UTS between two bands is allowed, a case in which Tx chains are changed to band A from two bands other than the band A does not occur. Yet, if UTS among three or more bands is allowed, Tx chains may be changed to the band A from two bands other than the band A. This may be considered to define Condition-1.
>>>Or, a case in which a previous transmission occurred on any other band (in a deactivated state)
>>Condition-2: When a state of a Tx chain at a timing point T_j is not A(2T), UTS may be triggered. For example, a Tx state in which UTS may be triggered at the corresponding timing point may be one of the following.
>>>A(1T)+B(1T), A(1T)+C(1T), A(1T)+D (1T), B(1T)+C(1T), B(1T)+D (1T), C(1T)+D(1T), B(2T), C(2T), D(2T)
>>Condition-3: UTS may be triggered if a previous transmission is A(1p) and a 2p transmission is not possible in band A (e.g., a state of A(1T)) at a timing point T_j.
>When A(1p) occurs as a current transmission,
>>Condition-4: If a previous transmission was X(2p), UTS may be triggered. In this case, X denotes a band other than A.
>>A case that Option1 is configured as a UTS option (i.e., a UTS option value is switchedUL)
>>>Condition-5: If a previous transmission was X(1p) or X(2p), UTS may be triggered. In this case, X denotes a band other than A.
>>A case in which Option 2 is configured as a UTS option (i.e., a UTS option value is dualUL)
>>>Condition-6: If a previous transmission is X(1p) or X(2p), if 2p transmission in band X where the previous transmission was at a timing point T_j is impossible, and if it is not A(1T) at the timing point T_j, UTS may be triggered.
>>>>Condition-7: If it is not A(1T) or A(2T) at a timing point T_j, UTS may be triggered. FIG. 9 (a) illustrates a case that a Tx state of a UE at a timing point T_i is A(1T) and that a current transmission is A(1p). FIG. 9 (b) illustrates a case that a Tx state of a UE is A(2T) at a timing point T_i and that a current transmission is A(1p). When dualUL is configured as a UTS option for the UE, a BS and the UE may determine that UTS is triggered when the Tx state of the UE and the state of the current transmission are different from the examples of FIG. 9 (a) and FIG. 9 (b) at the timing point T_i.
>>If Option1 is configured (or applied) for some BC in which the band A is included, and Option2 is configured (or applied) for other BC in which the band A is included,
>>>Condition-8: If a previous transmission was in a band other than the band A in the Option 1 configured BC, UTS may be triggered according to the Condition-5.
>>>Condition-9: If a previous transmission was in a band other than the band A in the Option 2 configured BC, UTS may be triggered according to the Condition-6 and/or Condition-7.
>When A(1p)+B(1p) occurs as a current transmission,
>>Option 2 is configured (or applied) as a UTS option (i.e., a UTS option value is dualUL)
>>>Condition-10: UTS can be triggered if a previous transmission was 2p (in any band d).
>>>Condition-11: UTS may not be triggered if a previous transmission was one of the 3 kinds below. Otherwise, UTS may be triggered.
>>>A(1p) or B(1p) or A(1p)+B(1p). FIG. 10 (a) illustrates a case in which a previous transmission is A(1p) and a current transmission is A(1p)+B(1p), FIG. 10 (b) illustrates a case in which a previous transmission is B(1p) and a current transmission is A(1p)+B(1p), and FIG. 10 (c) illustrates a case in which a previous transmission is A(1p)+B(1p). When dualUL is configured for a UE as a UTS option, a BS and the UE may determine that UTS is triggered when a state of the previous transmission and a state of the current transmission are different from those of the examples of FIG. 10.
>>>Condition-12: If a Tx state of a UE at a timing point T_i is A(1T)+B(1T), UTS may not be triggered. Otherwise, UTS may be triggered.

### Implementation 2) UTS Triggering Condition #2

When A(1p)+B(1p) occurs as a current transmission, if a previous transmission is A (2p) or A(1p)+C(1p) or A(1p)+D(1p), UTS may be triggered as described in Condition-10 and/or Condition-11. Even if UTS is triggered according to Condition-10 and/or Condition-11, in some implementations, switching of only one of 2 Tx chains may occur. In this case, UTS may be performed according to one of the following.
>Alt-1: UTS may be triggered only in a transmission of band B. That is, UTS may be triggered for only a band in which a previous transmission has not occurred (i.e., a band to which a Tx chain is not connected before a UTS occurrence) in band(s) of a current transmission.
>Alt-2: UTS may be triggered for both band A and band B.

The above expressions of band A and band B are for the band in which the current transmission has occurred and do not refer to a specific band. In addition, when UTS is triggered under the above conditions, the UTS may be triggered even in the band located (connected) before a Tx chain is switched (i.e., a UTS gap may exist).

When A(1p)+B(1p) occurs as a current transmission, if a previous transmission is B(2p) or B(1p)+C(1p) or B(1p)+D(1p), UTS may be triggered as described in Condition-10 and/or Condition-11. However, switching may occur only in one of 2 Tx chains. In this case, UTS may be performed according to one of the following.
>Alt-1: UTS may be triggered only for a transmission of band A. That is, UTS may be triggered only for band(s) in which no previous transmission has occurred (i.e., a band to which no Tx chain is connected before UTS occurs) among band(s) of a current transmission.
>Alt-2: UTS may be triggered for both band A and band B.

The above expressions of band A and band B are for a band in which a current transmission has occurred and do not refer to a specific band. In addition, when UTS is triggered under the above conditions, the UTS may be triggered even in a band located (connected) before a Tx chain is switched (i.e., a UTS gap may exist).

Depending on the capability of a UE, it may operate as one of Alt 2-1 or Alt 2-2. To this end, the UE may report one of {Alt-1, Alt-2, both} to a BS through a UE capability signal. In this case, such a reporting may be performed in a BC unit including band A and/or band B, or may be performed irrespective of BC.

The BS may configure one of {Alt-1 and Alt-2} to the UE when receiving a report of the UE capability signal. In this case, a configuration method may be performed using a DCI for scheduling a corresponding UL transmission or through higher layer signaling such as RRC, MAC Control Element (CE), and/or the like. In addition, such a configuration may be provided in units of BCs, or may be provided irrespective of BC (i.e., per UE configuration).

In addition, a default operation for this may be defined. That is, when the UE does not report the related UE capability signal (or before reporting), the BS may arbitrarily select and configure one of Alt-1 or Alt-2. One operation of Alt-1 or Alt-2 may be defined as a default operation when the UE is not provided with a configuration of the corresponding RRC or the like (or before the configuration of the corresponding RRC or the like is provided to the UE).

### Implementation 3) UTS Triggering Condition #3

When A(1p) occurs as a current transmission (and a UL transmission simultaneously transmitted does not occur in another band), if a previous transmission is one of B(2p), C(2p), D(2p), B(1p)+C(1p), B(1p)+D(1p), and C(1p)+D(1p), UTS may be triggered. However, in this case, it may be selected whether to switch only 1 Tx chain or all of 2 Tx chains to band A. In this case, the UTS may be performed according to one of the following.
>Alt-1: Only 1 Tx chain is switched to the band A, and the remaining 1 Tx chain is not switched. In this case, UTS may be triggered only in a band where the current transmission has occurred, or the UTS may be triggered in all band(s) for the current transmission and the previous transmission.
>Alt-2:2 Tx chains are switched to the band A. In this case, UTS may be triggered in both the band in which the current transmission occurred and the band in which the previous transmission occurred.

The above expression ‘band A’ is intended to refer to the band in which the current transmission has occurred and does not refer to a specific band. In addition, when the UTS is triggered under the above conditions, the UTS may be triggered even in the band located (connected) before the Tx chain is switched (i.e., a UTS gap may exist).

Depending on the capability of a UE, the UE may operate as one of Alt-1 and Alt-2. To this end, the UE may report one of {Alt-1, Alt-2, both} to a BS through a UE capability signal. In this case, such reporting may be performed in a BC unit including band A and/or band B, or may be performed irrespective of BC.

The BS may configure one of {Alt-1 and Alt-2} for the UE. In this case, a configuration method may be performed using a DCI for scheduling a corresponding UL transmission or through higher layer signaling such as RRC, MAC CE, and/or the like. Also, such a configuration may be provided in units of BCs, or may be provided irrespective of BC (i.e., per UE configuration).

In addition, a default operation for this may be defined. That is, when the UE does not report a related UE capability signal (or before reporting the same), the BS may arbitrarily select and configure one of Alt-1 or Alt-2. One operation of Alt-1 or Alt-2 may be defined as a default operation when a configuration of corresponding RRC or the like is provided to the UE (or before the configuration of corresponding RRC or the like is provided to the UE).

### Implementation 4) UTS Triggering Condition #4

When operating by Alt-1 of Implementation 3 described above (i.e., when A(1p) occurs as a current transmission (i.e., when a UL transmission simultaneously performed does not occur in another band), for a case that a previous transmission is one of B(2p), C(2p), D(2p), B(1p)+C(1p), B(1p)+D(1p), and C(1p)+D(1p), an operation of switching only 1 Tx chain to band A), the Tx chain that is to be switched to the band A may need to select whether to be switched from a Tx chain of which one of previous band(s). In this case, UTS may be performed according to one of the following.
>Alt-1: A Tx chain of a band/carrier (or a band to which the corresponding carrier belongs) corresponding to a lowest index (or a highest index) among band(s)/carrier(s) having/connected to Tx chain(s) before triggering UTS is switched. In this case, if there are all 2 Tx chains in one band like B (2T), a UE may randomly switch one Tx chain.
>Alt-2: A Tx chain of a band/carrier (or a band to which the corresponding carrier belongs) corresponding to a band/carrier in which a latest UL transmission is older (or more recent) among band(s)/carrier(s) having/connected to Tx chain(s) before triggering UTS is switched. In this case, if there are all 2 Tx chains in one band, like B (2T), a UE may randomly switch one Tx chain.
>Alt-3: A Tx chain of a band with the least activated (or configured) carrier among band(s) having/connected to Tx chain(s) before triggering UTS is switched. In this case, when there are all 2 Tx chains in one band like B (2T), a UE may randomly switch one Tx chain.
>Alt-4: A Tx chain of a band in which Option 1 is configured with respect to BC with band A among band(s) having/connected to Tx chain(s) before triggering UTS is switched. For example, if there are four bands of band A, band B, band C, and band D, a band combination or band-pairs including the band A may include {A,B}, {A,C}, and {A,D}. For {A,C}, Option 2 is configured as a UTS option,. For {A,D}, and Option 1 is configured as a UTS option. When A(1p) occurs as a current transmission while the state of Tx chains of a previous transmission is C(1T)+D (1T), a Tx chain in the band D moves to the band A. That is, Tx chains are changed from C(1T)+D (1T) to C(1T)+A(1T). In Alt-4, if there are all 2 Tx chains in one band like B (2T), a UE may randomly switch one Tx chain.
>Alt-5: A Tx chain of any specific band or carrier (band to which the corresponding carrier belongs) among band(s)/carrier(s) having or connected to Tx chain(s) before triggering UTS may be switched. Here, the “any specific band or carrier” may be indicated/configured by separate signaling (e.g., DCI-based signaling).
>Alt-6: Among carrier(s) having/connected to Tx chain(s) (or band(s) to which the corresponding carrier(s) belong) before triggering UTS, a Tx chain may be switched from a band/carrier with a smallest (or largest) SCS of an active BWP within the corresponding band/carrier may be switched. For example, when 15 kHz SCS and 30 KHz SCS set for band/carrier B and band/carrier C are configured in active BWPs of the corresponding bands/carriers, respectively, if UTS is triggered as 1p UL transmission in band A in a state of B (1T)+C(1T), a Tx chain may be switched to the band/carrier A from the band/carrier B with the smallest SCS (or from the band/carrier C with the largest SCS). In this method, if the SCS of the band/carrier B and the SCS of the band/carrier C are the same, the Tx chain may be switched from a band/carrier with a lowest (or highest) index of a band/carrier, or (in this situation, whether a UE will operate to switch a Tx chain from which band/carrier) may be indicated/configured by separate signaling.
>Alt-7: Among carrier(s) having/connected to Tx chain(s) before triggering UTS (or band(s) to which the corresponding carrier(s) belong), a Tx chain may be switched from a band/carrier in which SCS setting value of an active BWP in the corresponding band/carrier is the same as an SCS setting value of an active BWP of a band/carrier in which 1p UL transmission occurs. For example, when 15 kHz SCS set for band/carrier B and 30 kHz SCS set for band/carrier C are configured in active BWPs of the corresponding bands/carriers, respectively, when UTS is triggered as 1p UL transmission occurs in band A in a state of B (1T)+C(1T) the 15 kHz SCS is set in an active BWP of the band/carrier A, a Tx chain is switched from the band/carrier B to the band/carrier A. If 30 kHz SCS is set in the active BWP of the band/carrier A, a Tx chain may be switched from the band/carrier C to the band/carrier A. In this method, if the SCS of the band/carrier B and the SCS of the band/carrier C are the same, a Tx chain may be switched from a band/carrier with the lowest (or highest) (cell) index of the band/carrier or (in this situation, whether a UE will operate to switch the Tx chain in which band/carrier) may be indicated/configured through separate signaling.
>Alt-8: Among carrier(s) having/connected to Tx chain(s) (or band(s) to which the corresponding carrier(s) belong) before triggering UTS, a Tx chain may be switched from a band/carrier having a smaller UTS gap reported/configured. In this method, if the same UTS gap was reported/configured for all the band/carrier having/connected to the Tx chain, a Tx chain may be switched from a band/carrier with the lowest (or highest) (cell) index of the band/carrier, or (in this situation, whether a UE will operate to which a Tx chain from which band/carrier) may be indicated/configured through separate signaling.
>Alt-9: A difference between a downlink frame timing and an uplink frame timing may occur due to propagation delay. In order to adjust such a difference between the downlink frame timing and the uplink frame timing, a Timing Advance (TA) that performs a UL transmission by a predetermined time ahead of the downlink frame timing relatively is used. Serving cells having a UL to which the same timing advance is applied and using the same timing reference cell are grouped into TAGs. Each of the TAGs includes at least one serving cell having a configured UL, and the mapping to TAG of each serving cell is configured by RRC. In consideration of TAG, among carrier(s) having/connected to Tx chain(s) before triggering UTS (or band(s) to which the corresponding carrier(s) belong), a Tx chain may be switched from a band/carrier belonging to the same TAG as the band/carrier in which a UL transmission has occurred. In this method, when band(s)/carrier(s) having/connected to Tx chain belongs to the same TAG, a Tx chain may be switched from a band/carrier with the lowest (or highest) (cell) index of the band/carrier (or, in this situation, whether a UE will operate to switch a Tx chain from which band/carrier) may be indicated/configured through separate signaling.

The band(s) mentioned in the above-described Alts is an expression to refer to band(s) in which a current transmission (or a previous transmission) has occurred and does not refer to a specific band. In addition, when UTS is triggered under the above conditions, it may be triggered even in the band located (connected) before a Tx chain is switched (i.e., a UTS gap may exist).

When one of two Tx chains before triggering UTS is connected to an active band/carrier and the other is connected to a deactivated band/carrier or a band/carrier in a dormant (BWP) state, a UE may switch the Tx chain in the deactivated (dormant) band/carrier.

Alternatively, it may operate by one of the above Alts according to capability of a UE. To this end, the UE may report one of the corresponding Alts to a BS through a UE capability signal. In this case, such reporting may be performed in a BC unit including band A, or may be performed irrespective of a BC.

The BS may configure one of the Alts to the UE. In this case, a configuration method may be performed using a DCI for scheduling a corresponding UL transmission or through higher layer signaling such as RRC, MAC CE, and/or the like. Also, such a configuration may be provided in units of BCs, or may be provided irrespective of BC (i.e., per UE configuration).

In addition, a default operation for this may be defined. That is, when the UE does not report a related UE capability signal (or before reporting it), the BS may randomly select and configure one of the above-described Alts. If the UE is not provided with the configuration of the corresponding RRC or the like is provided to the UE (or before the configuration of the corresponding RRC or the like is provided to the UE), one operation of the Alts may be defined as a default operation.

### Implementation 5) UTS Triggering Condition #5

When UTS is performed only between two bands/carriers, if A(1p)+B(1p) occurs as a current transmission, since a Tx chain would have remained the same for one of band A and band B, a UTS gap occurs only once and a start timing point of A(1p) and a start timing point of B(1p) do not change. However, if UTS is performed between more than two bands/carriers, all of the Tx chains of the current transmission A(1p)+B(1p) may have been connected to other band(s)/carrier(s) in a previous transmission, a UTS gap may occur twice and a start timing point of A(1p) and a start timing point of B(1p) may be different. As A(1p)+B(1p) occurs as a current transmission and UTS is triggered accordingly, if the start timing point of A(1p) and the start timing point of B(1p) do not match, UTS may be performed according to one of the following. This situation may correspond to a case where a state of a previous Tx chain is not A(1T)+B(1T). Also, this situation may correspond to a situation where B(1p) starts before A(1p) transmission configured/scheduled as the current transmission is finished.
>Alt-1: UTS may be triggered simultaneously in band A and band B according to a UL transmission preceding between A(1p) and B(1p). That is, a UTS gap may be located at the same timing point in the band A and the band B.
>Alt-2: UTS may be triggered in band A or band B according to each transmission timing point of A(1p) and B(1p). Alternatively, a UTS gap for the band A and a UTS gap for the band B may be located at different timing points, respectively.

In the above description, the expression of the band A or the band B is for a band in which a current transmission occurs and does not refer to a specific band. In addition, when UTS is triggered under the above conditions, the UTS may be triggered even in a band located (connected) before a Tx chain is switched (i.e., a UTS gap may exist).

Alternatively, depending on a capability of a UE, the UE may operate by Alt-1 or Alt-2. To this end, the UE may report one of {Alt-1, Alt-2, both} to a BS through a UE capability signal. In this case, such reporting may be performed in a BC unit including the band A, or may be performed irrespective of BC.

A BS may configure one of {Alt-1 and Alt-2} for a UE. In this case, a configuration method may be performed using a DCI for scheduling a corresponding UL transmission or through higher layer signaling such as RRC, MAC CE, and/or the like. In addition, such a configuration may be provided in units of BCs, or may be provided irrespective of BC (i.e., per UE configuration).

In addition, a default operation for this may be defined. That is, when a UE does not report a related UE capability signal (or before the UE reports it), a BS may randomly select and configure one of Alt-1 or Alt-2. One operation of Alt-1 or Alt-2 may be defined as a default operation when the UE is not provided with a configuration of corresponding RRC or the like (or before the configuration of the corresponding RRC or the like is provided to the UE).

According to some implementations of the present disclosure, as the condition(s) under which UTS occurs between more than two bands become clear, a BS and a UE may identify the effects of UTS on DL/UL interference, etc.

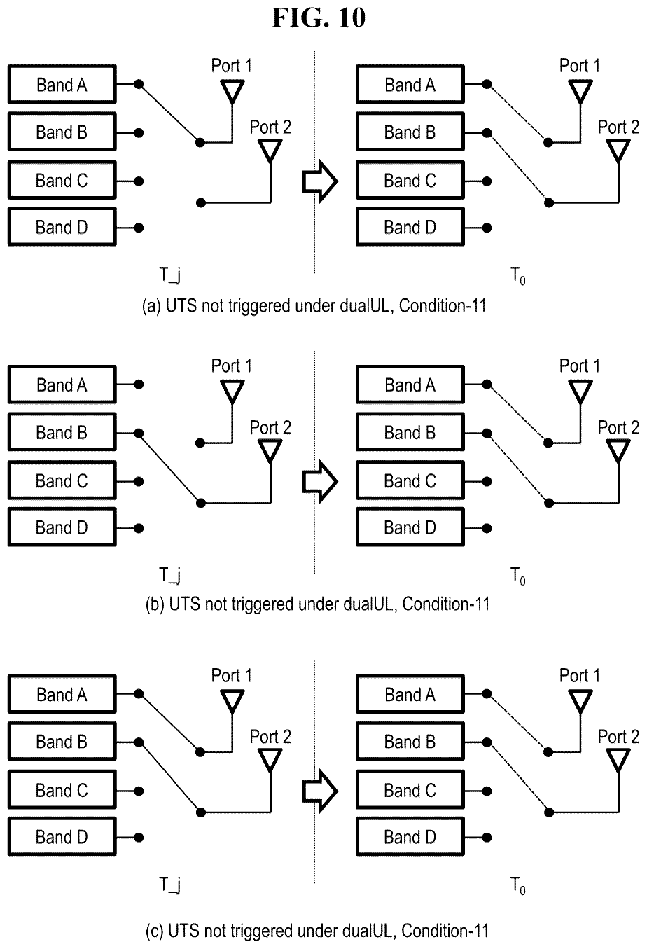

FIG. 11 illustrates a flow of a UL signal transmission in a UE according to some embodiments of the present disclosure.

The UE may perform operations according to some implementations of the present disclosure in association with an UL signal transmission. The UE may include at least one transceiver; at least one processor; and at least one computer memory operably connectable to the at least one processor and storing instructions that, when executed, cause the at least one processor to perform operations according to some implementations of the present disclosure. A processing device for a UE may include at least one processor; and at least one computer memory operably connectable to the at least one processor and storing instructions that, when executed, cause the at least one processor to perform operations according to some implementations of the present disclosure. A computer readable (non-transitory) storage medium may store at least one computer program including instructions that, when executed by at least one processor, cause the at least one processor to perform operations according to some implementations of the present disclosure. A computer program or a computer program product may include instructions recorded in at least one computer readable (non-transitory) storage medium and causing, when executed, (at least one processor) to perform operations according to some implementations of the present disclosure.

In the UE, the processing device, the computer-readable (non-transitory) storage medium, and/or the computer program product, the operations may include: receiving an RRC configuration including UTS-related information on a plurality of bands including at least a first band, a second band, and a third band (S1101) and receiving scheduling information for scheduling a current UL transmission in at least one of a plurality of the bands (S1103). The operations may include determining whether UTS conditions are satisfied for the current UL transmission based on the RRC configuration, the scheduling information, and a UL transmission preceding the current UL transmission (S1105). When the UTS conditions are satisfied (S1105, Yes), UTS occurs for carrier(s) of a corresponding band pair (S1107a). For example, the operations may include omitting the UL transmission during a UL switching gap based on the UTS conditions being satisfied (S1105, Yes) (S1107a). When the UTS conditions are not satisfied (S1105, No), the UTS does not occur for the carrier(s) of the corresponding band pair (S1107b). For example, the operations may include performing the preceding UL transmission and the current UL transmission without interruption, i.e., without the UL switching gap based on the UTS conditions not being satisfied (S1105, No) (S1107b). The UTS conditions may include: i) a first condition-based on the current UL transmission being a 2-port transmission, the preceding UL transmission occurs in at least one band other than a band in which the current UL transmission occurs, ii) a second condition-based on the current UL transmission being a 1-port transmission and based on allowing the UE to perform UL transmissions in different bands, the preceding UL transmission is not a 1-port transmission or a 2-port transmission occurring in the band in which the current UL transmission occurs; and iii) a third condition-based on the current UL transmission being a 1-port transmission in the first band and a 1-port transmission in the second band and based on allowing the UE to perform the UL transmissions in the different bands, the preceding UL transmission is not the 1-port transmission in the first band, the 1-port transmission in the second band, or the 1-port transmission in the first band and the 1-port transmission in the second band.

In some implementations, the operations may include: in relation to the third condition, transmitting a UE capability report on whether to perform the UTS only for the UL transmission in the second band or for UL transmissions in both the first band and the second band; and omitting the UL transmission in the first band or the UL transmissions in the first band and the second band based on the third condition being satisfied and based on the UE capability report.

In some implementations, the above operations may include: in relation to the third condition, receiving configuration information on whether to perform the UTS only for the UL transmission in the second band or for UL transmissions in both the first band and the second band; and omitting the UL transmission in the first band or the UL transmissions in the first band and the second band according to the configuration information based on the third condition being satisfied.

In some implementations, the operations may include: in relation to the second condition, performing a UE capability report on whether to switch only one of two Tx chains or both of the two Tx chains; and based on the second condition being satisfied and based on the UE capability report, switching only one of the two Tx chains of the UE to the band of the current UL transmission or both of the two Tx chains to the band of the current UL transmission.

In some implementations, the operations may include: in relation to the second condition, receiving configuration information on whether to switch only one of the two transmission (Tx) chains of the UE or both of the two Tx chains; and based on the second condition being satisfied, according to the configuration information, switching only one of the two Tx chains of the UE to the band of the current UL transmission or both of the two Tx chains to the band of the current UL transmission.

In some implementations, in the operations, based on the third condition being satisfied, based on that the 1-port transmission in the first band and the 1-port transmission in the second band overlap each other in time, and based on that a start of the 1-port transmission in the first band and a start of the 1-port transmission in the second band do not match, the UL switching gap may be determined based on a preceding UL transmission between the 1-port transmission in the first band and the 1-port transmission in the second band with respect to the first band and the second band. In some implementations, the 1-port transmission in the first band and the 1-port transmission in the second band overlapping each other in time may be omitted during the switching gap determined based on the preceding UL transmission between the 1-port transmission in the first band and the 1-port transmission in the second band.

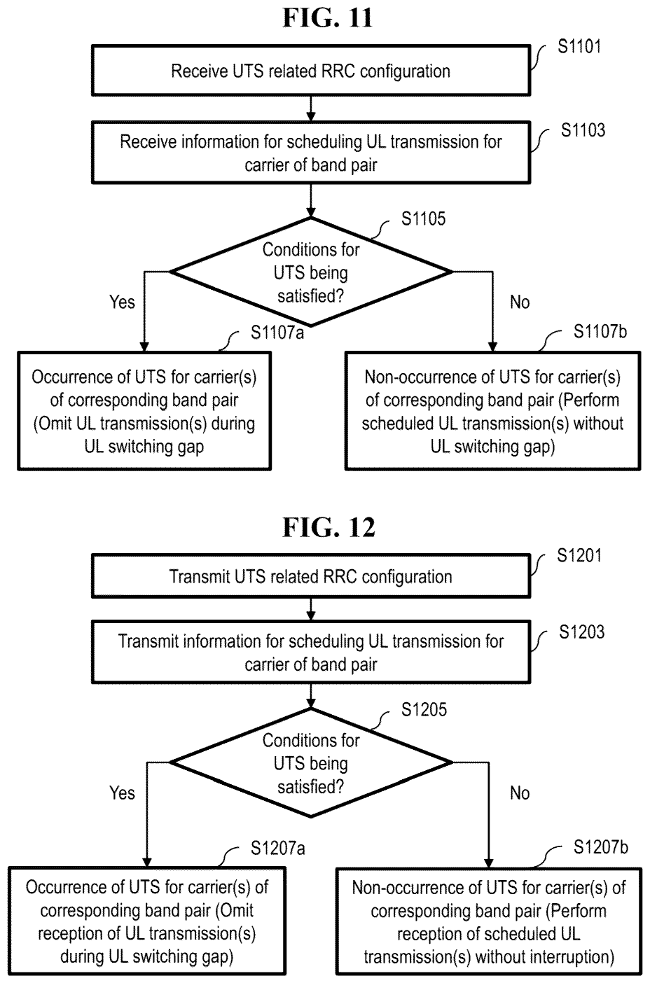

FIG. 12 illustrates a flow of a UL signal reception in a BS according to some embodiments of the present disclosure.

The BS may perform operations according to some implementations of the present disclosure in association with an UL signal reception. The BS may include at least one transceiver; at least one processor; and at least one computer memory operably connectable to the at least one processor and storing instructions that, when executed, cause the at least one processor to perform operations according to some implementations of the present disclosure. A processing device for a BS may include at least one processor; and at least one computer memory operably connectable to the at least one processor and storing instructions that, when executed, cause the at least one processor to perform operations according to some implementations of the present disclosure. A computer readable (non-transitory) storage medium may store at least one computer program including instructions that, when executed by at least one processor, cause the at least one processor to perform operations according to some implementations of the present disclosure. A computer program or a computer program product may include instructions recorded in at least one computer readable (non-transitory) storage medium and causing, when executed, (at least one processor) to perform operations according to some implementations of the present disclosure.

In the BS, the processing device, the computer-readable (non-transitory) storage medium, and/or the computer program product, the operations may include: transmitting an RRC configuration including UTS-related information on a plurality of bands including at least a first band, a second band, and a third band to a UE (S1201) and transmitting scheduling information for scheduling a current UL transmission in at least one of a plurality of the bands to the UE (S1203). The operations may include determining whether UTS conditions are satisfied for the current UL transmission based on the RRC configuration, the scheduling information, and a UL transmission preceding the current UL transmission (S1205). When the UTS conditions are satisfied (S1205, Yes), UTS occurs for carrier(s) of a corresponding band pair (S1207a). For example, the operations may include omitting a reception of the UL transmission of the UE during a UL switching gap based on the UTS conditions being satisfied (S1205, Yes) (S1207a). When the UTS conditions are not satisfied (S1205, No), the UTS does not occur for the carrier(s) of the corresponding band pair (S1207b). For example, the operations may include performing a reception of the preceding UL transmission and the current UL transmission from the UE without interruption, i.e., without the UL switching gap based on the UTS conditions not being satisfied (S1205, No) (S1207b). The UTS conditions may include: i) a first condition-based on the current UL transmission being a 2-port transmission, the preceding UL transmission occurs in at least one band other than a band in which the current UL transmission occurs, ii) a second condition-based on the current UL transmission being a 1-port transmission and based on allowing the UE to perform UL transmissions in different bands, the preceding UL transmission is not a 1-port transmission or a 2-port transmission occurring in the band in which the current UL transmission occurs; and iii) a third condition-based on the current UL transmission being a 1-port transmission in the first band and a 1-port transmission in the second band and based on allowing the UE to perform the UL transmissions in the different bands, the preceding UL transmission is not the 1-port transmission in the first band, the 1-port transmission in the second band, or the 1-port transmission in the first band and the 1-port transmission in the second band.

In some implementations, the operations may include: in relation to the third condition, receiving a UE capability report on whether to perform the UTS only for the UL transmission in the second band or for UL transmissions in both the first band and the second band; and omitting the UL transmission in the first band or the UL transmissions in the first band and the second band based on the third condition being satisfied and based on the UE capability report.

In some implementations, the operations may include: in relation to the third condition, transmitting configuration information on whether to perform the UTS only for the UL transmission in the second band or for UL transmissions in both the first band and the second band; and omitting the UL transmission in the first band or a reception of the UL transmissions in the first band and the second band according to the configuration information based on the third condition being satisfied.

In some implementations, the operations may include: in relation to the second condition, receiving a UE capability report on whether to switch only one of two transmission (Tx) chains of the UE or both of the two Tx chains; and based on the second condition being satisfied and based on the UE capability report, determining or assuming that only one of the two Tx chains of the UE is switched to the band of the current UL transmission or that both of the two Tx chains are switched to the band of the current UL transmission.

In some implementations, the operations may include: in relation to the second condition, receiving configuration information on whether to switch only one of the two transmission (Tx) chains of the UE or both of the two Tx chains; and based on the second condition being satisfied, according to the configuration information, determining or assuming that only one of the two Tx chains of the UE is switched to the band of the current UL transmission or that both of the two Tx chains are switched to the band of the current UL transmission.

In some implementations, based on the third condition being satisfied, based on that the 1-port transmission in the first band and the 1-port transmission in the second band overlap each other in time, and based on that a start of the 1-port transmission in the first band and a start of the 1-port transmission in the second band do not match, the UL switching gap may be determined based on a preceding UL transmission between the 1-port transmission in the first band and the 1-port transmission in the second band with respect to the first band and the second band.

In some implementations, the reception of the 1-port transmission in the first band and the 1-port transmission in the second band overlapping each other in time may be omitted during the switching gap determined based on the preceding UL transmission between the 1-port transmission in the first band and the 1-port transmission in the second band.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

The implementations of the present disclosure may be used in a BS, a UE, or other equipment in a wireless communication system.

1. A method of transmitting an Uplink (UL) signal by a User Equipment (UE) in a wireless communication system, the method comprising:
receiving an RRC configuration including Uplink Transmission Switching (UTS) related information regarding a plurality of bands including at least a first band, a second band, and a third band;
receiving scheduling information for scheduling a current UL transmission in at least one of a plurality of the bands;
determining whether UTS conditions are satisfied for the current UL transmission based on the RRC configuration, the scheduling information, and a UL transmission preceding the current UL transmission;
omitting a UL transmission during a UL switching gap based on the UTS conditions being satisfied; and
performing the preceding UL transmission and the current UL transmission without interruption based on the UTS conditions not being satisfied,
wherein the UTS conditions comprise;
i) a first condition-based on the current UL transmission being a 2-port transmission, the preceding UL transmission occurs in at least one band other than a band in which the current UL transmission occurs,
ii) a second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs, and
iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

2. The method of claim 1, comprising:
in relation to the third condition, transmitting a UE capability report regarding whether to perform the UTS only for the UL transmission in the second band or for UL transmissions in both the first band and the second band; and
omitting the UL transmission in the first band or the UL transmissions in the first band and the second band based on the third condition being satisfied and based on the UE capability report.

3. The method of claim 1, comprising:
in relation to the third condition, receiving configuration information regarding whether to perform the UTS only for the UL transmission in the second band or for UL transmissions in both the first band and the second band; and
omitting the UL transmission in the first band or the UL transmissions in the first band and the second band according to the configuration information based on the third condition being satisfied.

4. The method of claim 1, comprising:
in relation to the second condition, performing a UE capability report regarding whether to switch only one of two Transmission (Tx) chains or both of the two Tx chains; and
based on the second condition being satisfied and based on the UE capability report, switching only one of the two Tx chains of the user equipment to the band of the current UL transmission or both of the two Tx chains to the band of the current UL transmission.

5. The method of claim 1, comprising:
in relation to the second condition, receiving configuration information regarding whether to switch only one of two Transmission (Tx) chains of the user equipment or both of the two Tx chains; and
based on the second condition being satisfied, according to the configuration information, switching only one of the two Tx chains of the UE to the band of the current UL transmission or both of the two Tx chains to the band of the current UL transmission.

6. The method of claim 1, wherein based on the third condition being satisfied, based on the 1-port transmission in the first band and the 1-port transmission in the second band overlapping each other in time, and based on a start of the 1-port transmission in the first band and a start of the 1-port transmission in the second band not matching, the UL switching gap is determined for the first band and the second band based on a preceding UL transmission between the 1-port transmission in the first band and the 1-port transmission in the second band.

7. The method of claim 6, wherein the 1-port transmission in the first band and the 1-port transmission in the second band overlapping each other in time are omitted during the switching gap determined based on the preceding UL transmission between the 1-port transmission in the first band and the 1-port transmission in the second band.

8. A user equipment transmitting an Uplink (UL) signal in a wireless communication system, the user equipment comprising:
at least one transceiver;
at least one processor; and
at least one computer memory operably connected to the at least one processor and storing instructions causing the at least one processor to perform operations when executed, the operations comprising:
receiving an RRC configuration including Uplink Transmission Switching (UTS) related information regarding a plurality of bands including at least a first band, a second band, and a third band;
receiving scheduling information for scheduling a current UL transmission in at least one of a plurality of the bands;
determining whether UTS conditions are satisfied for the current UL transmission based on the RRC configuration, the scheduling information, and a UL transmission preceding the current UL transmission;
omitting a UL transmission during a UL switching gap based on the UTS conditions being satisfied; and
performing the preceding UL transmission and the current UL transmission without interruption based on the UTS conditions not being satisfied,
wherein the UTS conditions comprise;
i) a first condition-based on the current UL transmission being a 2-port transmission, the preceding UL transmission occurs in at least one band other than a band in which the current UL transmission occurs,
ii) a second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs, and
iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

9-11. (canceled)

12. A base station receiving an Uplink (UL) signal from a user equipment in a wireless communication system, the base station comprising:
at least one transceiver;
at least one processor; and
at least one computer memory operably connected to the at least one processor and storing instructions causing the at least one processor to perform operations when executed, the operations comprising:
transmitting an RRC configuration including Uplink Transmission Switching (UTS) related information on a plurality of bands including at least a first band, a second band, and a third band to the user equipment;
transmitting scheduling information for scheduling a current UL transmission in at least one of a plurality of the bands to the user equipment;
determining whether UTS conditions are satisfied for the current UL transmission based on the RRC configuration, the scheduling information, and a UL transmission preceding the current UL transmission;
omitting a reception of a UL transmission of the UE during a UL switching gap based on the UTS conditions being satisfied; and
performing a reception of the preceding UL transmission and the current UL transmission from the user equipment without interruption based on the UTS conditions not being satisfied,
wherein the UTS conditions comprises;
i) a first condition-based on the current UL transmission being a 2-port transmission, the preceding UL transmission occurs in at least one band other than a band in which the current UL transmission occurs,
ii) a second condition-based on the current UL transmission being a 1-port transmission and based on the user equipment being allowed to perform UL transmissions in different bands, the preceding UL transmission is not a 1-port transmission or a 2-port transmission occurring in the band in which the current UL transmission occurs; and
iii) a third condition-based on the current UL transmission being a 1-port transmission in the first band and a 1-port transmission in the second band and based on the user equipment being allowed to perform the UL transmissions in the different bands, the preceding UL transmission is not the 1-port transmission in the first band, the 1-port transmission in the second band, or the 1-port transmission in the first band and the 1-port transmission in the second band.

13. The base station of claim 12, the operations comprising:
in relation to the third condition, receiving a UE capability report regarding whether to perform the UTS only for the UL transmission in the second band or for UL transmissions in both the first band and the second band; and
band based on the third condition being satisfied and based on the UE capability report, omitting the UL transmission in the first band or the UL transmissions in the first band and the second.

14. The base station of claim 12, the operations comprising:
in relation to the third condition, transmitting configuration information regarding whether to perform the UTS only for the UL transmission in the second band or for UL transmissions in both the first band and the second band; and
omitting the UL transmission in the first band or a reception of the UL transmissions in the first band and the second band according to the configuration information based on the third condition being satisfied.

15. The base station of claim 12, the operations comprising:
in relation to the second condition, receiving a UE capability report regarding whether to switch only one of two Transmission (Tx) chains of the user equipment or both of the two Tx chains; and
based on the second condition being satisfied and based on the UE capability report, determining that only one of the two Tx chains of the user equipment is switched to the band of the current UL transmission or that both of the two Tx chains are switched to the band of the current UL transmission.

16. The base station of claim 12, the operations comprising:
in relation to the second condition, receiving configuration information regarding whether to switch only one of two Transmission (Tx) chains of the user equipment or both of the two Tx chains; and
based on the second condition being satisfied, according to the configuration information, determining that only one of the two Tx chains of the user equipment is switched to the band of the current UL transmission or that both of the two Tx chains are switched to the band of the current UL transmission.

17. The base station of claim 12, wherein based on the third condition being satisfied, based on the 1-port transmission in the first band and the 1-port transmission in the second band overlapping each other in time, and based on a start of the 1-port transmission in the first band and a start of the 1-port transmission in the second band not matching, the UL switching gap is determined for the first band and the second band based on a preceding UL transmission between the 1-port transmission in the first band and the 1-port transmission in the second band.

18. The base station of claim 17, wherein a reception of the 1-port transmission in the first band and the 1-port transmission in the second band overlapping each other in time is omitted during the switching gap determined based on the preceding UL transmission between the 1-port transmission in the first band and the 1-port transmission in the second band.
